(19) United States
(12) Patent Application Publication
(10) Pub. No.: US 2021/0048244 A1
(43) Pub. Date: Feb. 18, 2021

(54) NATURAL GAS LIQUIDS RECOVERY APPARATUS FOR CARBON DIOXIDE REINJECTION ENHANCED OIL RECOVERY, AND METHOD

(71) Applicant: Wolf Infrastructure Management Inc., Calgary (CA)

(72) Inventors: Ken Temple, Calgary (CA); Brent Mealey, Calgary (CA)

(21) Appl. No.: 16/995,536

(22) Filed: Aug. 17, 2020

Related U.S. Application Data
(60) Provisional application No. 62/887,751, filed on Aug. 16, 2019.

(30) Foreign Application Priority Data
Sep. 10, 2019 (CA) 3054910

(51) Int. Cl. F25J 3/02; B01D 5/00; B01D 53/00

(52) U.S. Cl. CPC F25J 3/0266; B01D 5/0003; B01D 2257/504; B01D 5/009; B01D 2257/304; B01D 53/002

(57) ABSTRACT

A method includes: providing a carbon dioxide recycle stream comprising natural gas liquids; separating, using a first distillation tower, the carbon dioxide recycle stream into a first vapor fraction and a first liquid fraction; cooling and partially condensing the first vapor fraction in a heat exchanger to yield a first carbon dioxide stream and a reflux stream; and separating, using a second distillation tower, the first liquid fraction into a second carbon dioxide stream and a natural gas liquids rich stream.

### CROSS-REFERENCE TO RELATED APPLICATIONS

This application claims the benefit of U.S. Provisional Application No. 62/887,751 filed on Aug. 16, 2019, and Canadian Patent Application No. 3,054,910 filed on Sep. 10, 2019, the contents of which are incorporated herein by reference in their entireties.

### FIELD

The subject application generally relates to oil and gas recovery, and in particular to a natural gas liquids recovery apparatus for carbon dioxide reinjection enhanced oil recovery, and method.

### BACKGROUND

In the field of oil and gas recovery, tertiary or “enhanced oil” recovery techniques are typically used to extract crude oil from oil reservoirs that cannot otherwise be accessed by more simple techniques, such as primary or secondary recovery techniques. One such tertiary technique is known as the tertiary oil recovery carbon dioxide (CO₂) miscible flood technique, which is typically used to recover oil from an older oil reservoir following primary and secondary production. By this technique, CO₂ gas is injected into the oil reservoir and, over time, the injected CO₂ is produced with oil, separated from the oil and reinjected into the reservoir. The produced CO₂ contains valuable natural gas liquids (NGL) that can be recovered and sold.

Recovery of NGL during CO₂ injection enhanced oil recovery has been described. For example, U.S. Pat. No. 4,753,666 to Pastor et al. describes a method of treating CO₂ rich gas for injection into a petroleum reservoir. CO₂ rich gas containing methane, nitrogen, ethane, propane, butanes, and heavier components is distilled such that substantially all of the heavier components are produced as a bottoms product and substantially all of the CO₂, ethane, and propane are produced as an overhead vapor. The presence of ethane and propane in the overhead vapors overcomes the effect of nitrogen and methane on minimum miscibility pressure in the reservoir, and the problems created by CO₂ freezing and the CO₂/ethane azeotrope are avoided, furthermore, a readily marketable liquid product is produced.

Improvements are generally desired. It is therefore at least an object to provide a novel natural gas liquids recovery apparatus for carbon dioxide reinjection enhanced oil recovery, and method.

### SUMMARY

It should be appreciated that this summary is provided to introduce a selection of concepts in a simplified form that are further described below in the detailed description. This summary is not intended to be used to limit the scope of the claimed subject matter.

In one aspect, there is provided a method, comprising: providing a carbon dioxide recycle stream comprising natural gas liquids; separating, using a first distillation tower, the carbon dioxide recycle stream into a first vapor fraction and a first liquid fraction; cooling and partially condensing the first vapor fraction in a heat exchanger to yield a first carbon dioxide stream and a reflux stream; and separating, using a second distillation tower, the first liquid fraction into a second carbon dioxide stream and a natural gas liquids rich stream.

The natural gas liquids rich stream may comprise substantially none of the propane from the carbon dioxide recycle stream.

The method may further comprise adding at least a portion of the reflux stream to the first distillation tower as reflux. The method may further comprise adding at least a portion of the reflux stream to the second distillation tower as reflux.

The method may further comprise passing the first liquid fraction through an additional heat exchanger heated by a refrigerant stream to at least partially vaporize the first liquid fraction. The refrigerant stream may comprise refrigerant liquid that subcools as it passes through the additional heat exchanger.

The method may further comprise combining the first carbon dioxide stream and the second carbon dioxide stream to yield a residual carbon dioxide stream.

The method may further comprise processing the natural gas liquids rich stream in a depropanizer to yield a propane rich stream and a processed natural gas liquids rich stream. The method may further comprise removing traces of one or more of carbon dioxide, hydrogen sulfide, and sulphur compounds from the natural gas liquids rich stream using an additional treatment unit. The method may further comprise removing traces of one or more of carbon dioxide, hydrogen sulfide, and sulphur compounds from the processed natural gas liquids rich stream using an additional treatment unit. The processed natural gas liquids rich stream may comprise substantially none of the propane from the carbon dioxide recycle stream.

In another aspect, there is provided an apparatus, comprising: a first distillation tower configured to separate a carbon dioxide recycle stream into a first vapor fraction and a first liquid fraction, the carbon dioxide recycle stream comprising natural gas liquids; a heat exchanger configured to cool and partially condense the first vapor fraction into a first carbon dioxide stream and a reflux stream; and a second distillation tower configured to separate the first liquid fraction into a second carbon dioxide stream and a natural gas liquids rich stream.

The natural gas liquids rich stream may comprise substantially none of the propane from the carbon dioxide recycle stream.

At least a portion of the reflux stream may be added to the first distillation tower as reflux. At least a portion of the reflux stream may be added to the second distillation tower as reflux.

The apparatus may further comprise an additional heat exchanger heated by a refrigerant stream, the heat exchanger being configured to at least partially vaporize the first liquid fraction. The refrigerant stream may comprise refrigerant liquid that subcools as it passes through the additional heat exchanger.

The apparatus may further comprise a depropanizer configured to process the natural gas liquids rich stream to yield a propane rich stream and a processed natural gas liquids rich stream. The apparatus may further comprise an additional treatment unit configured to remove traces of one or more of carbon dioxide, hydrogen sulfide, and sulphur compounds from the natural gas liquids rich stream. The apparatus may further comprise an additional treatment unit configured to remove traces of one or more of carbon dioxide, hydrogen sulfide, and sulphur compounds from the processed natural gas liquids rich stream.

### BRIEF DESCRIPTION OF THE DRAWINGS

Embodiments will now be described more fully with reference to the accompanying drawings in which:

FIG. 1 is a schematic process flow diagram of a carbon dioxide reinjection process;

FIG. 2 is a schematic process flow diagram of an NGL recovery process forming part of the carbon dioxide reinjection process of FIG. 1;

FIG. 3 is a schematic process flow diagram of another embodiment of a carbon dioxide reinjection process; and

FIG. 4 is a schematic process flow diagram of an NGL recovery process forming part of the carbon dioxide reinjection process of FIG. 3.

### DETAILED DESCRIPTION OF EMBODIMENTS

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including by not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

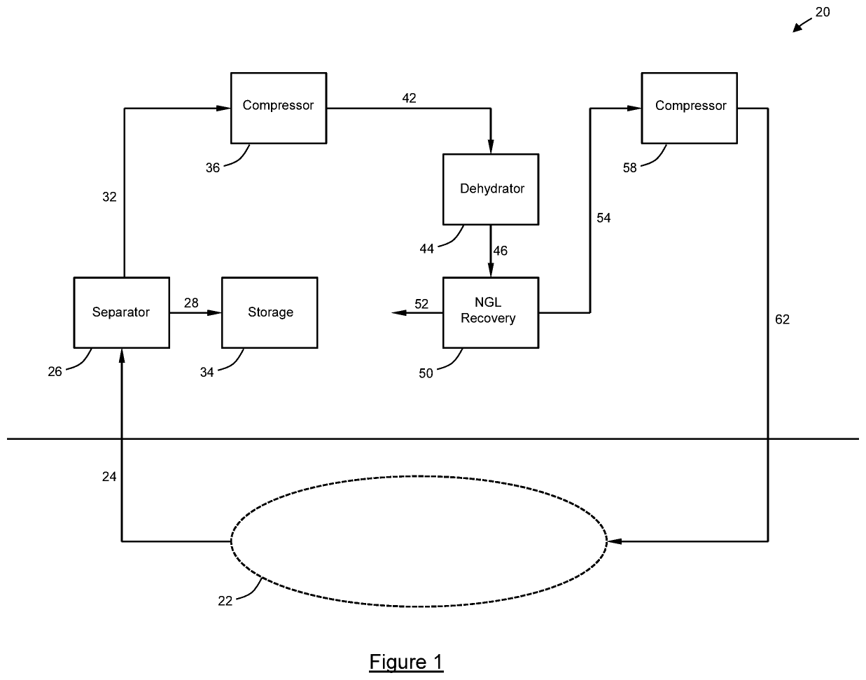

Turning now to FIG. 1, a carbon dioxide reinjection process is shown and is generally indicated by reference numeral 20. The carbon dioxide reinjection process 20 is configured to receive hydrocarbons and carbon dioxide from an underground hydrocarbon reservoir 22, separate heavy hydrocarbons and some of the natural gas liquids (NGL) from the carbon dioxide, and reinject a portion of the carbon dioxide into the underground hydrocarbon reservoir 22 for continued recovery. The separation of the NGL is carried out using a NGL recovery process that advantageously has greater efficiency than conventional NGL separation techniques.

The carbon dioxide reinjection process 20 receives a hydrocarbon feed stream 24 from the underground hydrocarbon reservoir 22. The hydrocarbon feed stream 24 is provided to the surface by a pressure differential existing between the underground hydrocarbon reservoir 22 and the surface, and/or is drawn to the surface from the underground hydrocarbon reservoir 22 by one or more pumps (not shown).

The hydrocarbon feed stream 24 comprises carbon dioxide, methane, ethane, NGL, heavy hydrocarbons, hydrogen sulfide (H₂S), helium, nitrogen, water, and combinations thereof, however it will be understood that the exact composition of the hydrocarbon feed stream 24 will vary from one location to another. The term “hydrocarbon” refers to any compound comprising or consisting of carbon and hydrogen atoms. The term “natural gas” refers to any hydrocarbon that exists in a gaseous phase under atmospheric or downhole conditions, and comprises methane and ethane, and may also comprise diminishing amounts of C₃ to C₈ hydrocarbons. The term “natural gas liquids” or NGL refers to components of natural gas that are separated from the gaseous state in the form of liquids, and may comprise ethane (C₂) and heavier hydrocarbons. Both natural gas and NGL are terms known in the art and are used herein as such. In contrast, the term “heavy hydrocarbons” refers to any hydrocarbon that exists in a liquid phase under atmospheric or downhole conditions, and generally comprises liquid crude oil, which may comprise C₉₊ hydrocarbons, branched hydrocarbons, aromatic hydrocarbons, C₅₊ natural gasoline condensates, and combinations thereof.

The hydrocarbon feed stream 24 is fed to a separator 26, which is configured to separate the hydrocarbon feed stream 24 into a heavy hydrocarbon stream 28 and a carbon dioxide recycle stream 32. In the example shown, the separator 26 is a single phase separator, or a plurality of phase separators arranged in parallel or in series. The heavy hydrocarbon stream 28 comprises a majority of the C₅₊ natural gasoline condensates and substantially all of the C₉₊ hydrocarbons from the hydrocarbon feed stream 24 and in this embodiment, the heavy hydrocarbon stream 28 comprises at least ninety (90) % of the heavy hydrocarbons from the hydrocarbon feed stream 24. The heavy hydrocarbon stream 28 is sent to a storage tank 34 for storage while awaiting further processing or transportation.

The carbon dioxide recycle stream 32 comprises most of the carbon dioxide from the hydrocarbon feed stream 24 and in this embodiment, the carbon dioxide recycle stream 32 comprises at least ninety (90) % of the carbon dioxide from the hydrocarbon feed stream 24. The carbon dioxide recycle stream 32 also comprises most of the natural gas from the hydrocarbon feed stream 24 and in this embodiment, the carbon dioxide recycle stream 32 comprises at least eighty (80) % of the natural gas from the hydrocarbon feed stream 24.

The carbon dioxide recycle stream 32 is fed to a compressor 36, which is configured to increase the pressure of the carbon dioxide recycle stream 32 to yield a compressed carbon dioxide recycle stream 42 having a pressure of about 1200 kPa or higher. In the example shown, the compressor 36 is a centrifugal compressor, but may alternatively be any of an axial, positive displacement, rotary or reciprocating compressor, or may be two or more of the aforementioned compressors arranged in parallel or in series.

The compressed carbon dioxide recycle stream 42 is fed to a dehydrator 44, which is configured to remove at least some of the water from the compressed carbon dioxide recycle stream 42 to yield a dehydrated carbon dioxide recycle stream 46. As will be understood, the removal of water by dehydrator 44 prevents corrosion and freezing downstream, which extends the service life of the downstream process components. In the example shown, the dehydrator 44 is a molecular sieve, but the dehydrator may alternatively be any suitable dehydration unit comprising a liquid desiccant, such as glycol, or any suitable dehydration unit comprising solid desiccant, such as silica gel or calcium chloride, and combinations thereof, or may be two or more of the aforementioned units arranged in parallel or in series. The dehydrator 44 removes substantially all the water from the carbon dioxide recycle stream 42. As a result, the water content of the dehydrated carbon dioxide recycle stream 46 is below 1 ppmv.

The dehydrated carbon dioxide recycle stream 46 is fed to an NGL recovery process 50, described below, which is configured to separate the dehydrated carbon dioxide recycle stream 46 into an NGL rich stream 52 and a residual carbon dioxide recycle stream 54.

The residual carbon dioxide recycle stream 54 is fed to a compressor 58, which is configured to increase the pressure of the residual carbon dioxide recycle stream 54 to yield a carbon dioxide injection stream 62. In the example shown, the compressor 58 is a centrifugal compressor, but may alternatively be any of an axial, positive displacement, rotary or reciprocating compressor, or may be two or more of the aforementioned compressors arranged in parallel or in series.

The carbon dioxide injection stream 62 is then injected downhole into the underground hydrocarbon reservoir 22. Alternatively, the carbon dioxide injection stream 62 may be sent to a carbon dioxide pipeline (not shown) or to storage (not shown).

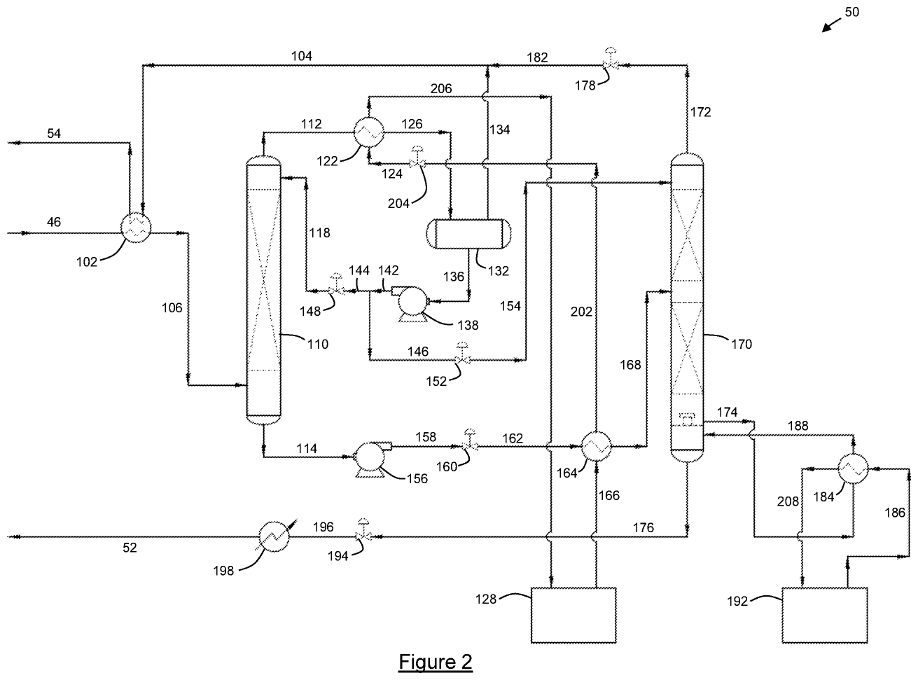

FIG. 2 shows the NGL recovery process 50. NGL recovery process 50 begins with the dehydrated carbon dioxide recycle stream 46 being passed through a heat exchanger 102, which is configured to indirectly cool the dehydrated carbon dioxide recycle stream 46 through heat exchange with a combined carbon dioxide stream 104 to yield a cold carbon dioxide recycle stream 106. During cooling, a portion of the NGL and heavy hydrocarbons in the dehydrated carbon dioxide recycle stream 46 will condense, thereby recovering non-stabilized NGL.

The cold carbon dioxide recycle stream 106 is fed to the bottom section of a first distillation tower 110, which is configured to separate the cold carbon dioxide recycle stream 106 into a first vapor fraction stream 112 and a first liquid fraction stream 114. In this embodiment, the first distillation tower 110 is a refluxed absorber distillation column comprising a packed bed mass transfer section. During operation, the cold carbon dioxide recycle stream 106 mixes with liquids in the packed bed mass transfer section and yields a vapor fraction and a liquid fraction. The vapor fraction flows up through the column, where it is counter-current contacted with a cold reflux liquids stream 118, resulting in mass transfer of hydrocarbons and CO₂ from the vapor fraction to the liquid phase in which they are absorbed. In particular, the absorbed hydrocarbons include a significant portion of the NGL. The overhead gas, namely the vapor fraction reaching the top of the column, exits the top of the first distillation tower 110 as the first vapor fraction stream 112.

The first vapor fraction stream 112 is passed through a heat exchanger 122, which is configured to indirectly cool the first vapor fraction stream 112 through heat exchange with a partially vaporized cold refrigerant liquid stream 124 to yield a partially condensed first vapor fraction stream 126. The partially vaporized cold refrigerant liquid stream 124, which forms part of a closed loop refrigerant system cooled by a mechanical refrigeration unit 128, described below, evaporates at least partially as it passes through the heat exchanger 122.

The partially condensed first vapor fraction stream 126 is fed to a separator 132, which is configured to separate the partially condensed first vapor fraction stream 126 into a second vapor fraction stream 134 and a second liquid fraction stream 136. In the example shown, the separator 132 is single stage flash separator, and more specifically a reflux drum/pressure vessel.

The second liquid fraction stream 136 is fed to a reflux pump 138, which is configured to boost the pressure of the second liquid fraction stream 136 to yield a pressurized second liquid fraction stream 142.

The pressurized second liquid fraction stream 142 is divided into a first pressurized second liquid fraction stream 144 and a second pressurized second liquid fraction stream 146. The first pressurized second liquid fraction stream 144 is fed through a valve 148, which is configured to limit the flow of the first pressurized second liquid fraction stream 144 by a desired amount to yield the cold reflux liquids stream 118, which is fed to the top section of the first distillation tower 110 to provide a distillation reflux stream. The second pressurized second liquid fraction stream 146 is fed through a valve 152, which is configured to limit the flow of the second pressurized second liquid fraction stream 146 by a desired amount to yield a second cold reflux liquids stream 154.

The first liquid fraction stream 114 exits the bottom of the first distillation tower 110 and is fed to a bottoms pump 156, which is configured to boost the pressure of the first liquid fraction stream 114 through pumping to yield a pressurized first liquid fraction stream 158. The pressurized first liquid fraction stream 158 is fed through a valve 160, which is configured to limit the flow of the pressurized first liquid fraction stream 158 in accordance with the output rate of the first liquid fraction stream 114 and the liquid level at the bottom of the first distillation tower 110, to yield a regulated first liquid fraction stream 162.

The regulated first liquid fraction stream 162 is passed through a heat exchanger 164, which is configured to indirectly heat and partially vaporize the regulated pressurized first liquid fraction stream 162 through heat exchange with a refrigerant liquid stream 166 to yield a two-phase stream 168. The refrigerant liquid stream 166, which forms part of the closed loop refrigerant system cooled by the mechanical refrigeration unit 128 described below, sub-cools as it transfers heat to the regulated pressurized first liquid fraction stream 162.

The two-phase stream 168 is fed to the middle section of a second distillation tower 170, which is configured to yield a third vapor fraction stream 172, an intermediate liquid fraction stream 174, and a third liquid fraction stream 176. In this embodiment, the second distillation tower 170 is a distillation column comprising an upper rectifier section, a middle section, a lower stripping section and a bottom section. During operation, in the middle section of the second distillation tower 170, the two-phase stream 168 comingles with liquids from the upper rectifier section and vapor from the lower stripping section to form a vapor fraction and a liquid fraction. The liquid fraction descends through the lower stripping section and exits the second distillation tower 170 as the intermediate liquid fraction stream 174. The vapor fraction, which mainly comprises vapor CO₂, hydrogen sulfide, methane, ethane, and propane, as well as a portion of butane and heavier hydrocarbons, flows up through the upper rectifier section. During this ascent, the vapor fraction is counter-current contacted with the second cold reflux liquids stream 154, resulting in transfer of additional hydrocarbons from the vapor fraction to the liquid phase in which they are absorbed. The overhead gas, namely the vapor fraction reaching the top of the upper rectifier section, exits the top of the second distillation tower 170 as the third vapor fraction stream 172.

The third vapor fraction stream 172 is fed through a valve 178, which is configured to limit the flow of the third vapor fraction stream 172 by a desired amount, in order to control the pressure in the second distillation tower 170, to yield a regulated third vapor fraction stream 182. The regulated third vapor fraction stream 182 is comingled with the second vapor fraction stream 134 to yield the combined carbon dioxide stream 104. The combined carbon dioxide stream 104 is then passed through the heat exchanger 102, which is configured to indirectly heat the combined carbon dioxide stream 104 through heat exchange with the dehydrated carbon dioxide recycle stream 46 to yield the residual carbon dioxide recycle stream 54. The residual carbon dioxide recycle stream 54 comprises generally all of the CO₂, methane, hydrogen sulfide, sulphur compounds, nitrogen, and ethane, and substantially all of the propane, from the dehydrated carbon dioxide recycle stream 46. The residual carbon dioxide recycle stream 54 also comprises a small and/or insignificant portion of the butane from the dehydrated carbon dioxide recycle stream 46.

Turning again to second distillation tower 170, the intermediate liquid fraction stream 174 drawn from the bottom of the stripping section is fed to a reboiler heat exchanger 184. The reboiler heat exchanger 184 is configured to heat the intermediate liquid fraction stream 174 through indirect heat exchange with a heat medium stream 186 to yield a heated, partially vaporized intermediate stream 188. The heat medium stream 186 forms part of a closed loop heat medium stream, described below, heated by a heat medium system 192.

The partially vaporized intermediate stream 188 is fed to the bottom section of the second distillation tower 170, where it is separated into a vapor fraction and a liquid fraction. The liquid fraction collects in the column, and exits the second distillation tower 170 as the third liquid fraction stream 176. The vapor fraction flows up through the lower stripping section of second distillation tower 170, where it is counter-current contacted with the liquid in the middle section which comprises, at least, the liquid portion of at least the two-phase stream 168 and the second cold reflux liquids stream 154 having descended the upper rectifier section of the second distillation tower 170.

The third liquid fraction stream 176 is fed through a valve 194, which is configured to limit the flow of the third liquid fraction stream 176 by a desired amount to yield a regulated third liquid fraction stream 196. The regulated third liquid fraction stream 196 then enters a heat exchanger 198, which is configured to cool the regulated third liquid fraction stream 196 through indirect heat exchange with air to yield the NGL rich stream 52. The NGL rich stream 52 comprises a majority of the butane, and substantially all of the pentane and heavier hydrocarbons, from the dehydrated carbon dioxide recycle stream 46. Additionally, the NGL rich stream 52 comprises only an insignificant portion of the propane from the dehydrated carbon dioxide recycle stream 46. In particular, the NGL rich stream 52 preferably comprises less than 1.0 molar percent propane, and more preferably comprises less than 0.5 molar percent propane. Additionally, the NGL rich stream 52 preferably comprises trace molar percent ethane, and more preferably comprises zero molar percent ethane.

The mechanical refrigeration unit 128 is configured to provide a cooled, closed loop refrigerant system. In this embodiment, the refrigerant is refrigerant grade propane, but in other embodiments the refrigerant may alternatively be another suitable refrigerant, such as ammonia, propylene, and the like. The mechanical refrigeration unit 128 supplies the refrigerant liquid stream 166, which is fed to the heat exchanger 164. In the heat exchanger 164, the refrigerant liquids sub-cool and thereby transfer heat to the regulated first liquid fraction stream 162, resulting in a sub-cooled refrigerant liquid stream 202. The sub-cooled refrigerant liquid stream 202 is fed through a valve 204, which is configured to reduce the pressure, partially flash and thereby evaporatively cool the refrigerant, to yield the partially vaporized cold refrigerant liquid stream 124. The partially vaporized cold refrigerant liquid stream 124 is fed to the heat exchanger 122, where heat transferred from the first vapor fraction stream 112 evaporates all of the refrigerant liquids to yield a refrigerant vapor stream 206. The refrigerant vapor stream 206 is returned to the mechanical refrigeration unit 128, where it is cooled and condensed into refrigerant liquid. In this embodiment, the refrigerant system is a single stage evaporative closed loop system, but in other embodiments the refrigerant system may alternatively be a two stage or multi-stage evaporative closed loop system.

The heat medium system 192 is configured to provide a heated, closed loop heating system. In this embodiment, the heat medium is a hot oil heat transfer fluid, but in other embodiments the heat medium may alternatively be another suitable fluid, such as glycol. The heat medium system 192 supplies the heated heat medium stream 186, which is fed to the reboiler heat exchanger 184. In the reboiler heat exchanger 184, the heat medium transfers heat to the intermediate liquid fraction stream 174, resulting in a cooled heat medium stream 208. The cooled heat medium stream 208 is returned to the heat medium system 192, where it is reheated.

As will be appreciated, the use of two (2) distillation towers, namely the first distillation tower 110 and the second distillation tower 170, enables the NGL recovery process 50 to advantageously be carried out at lower pressures than conventional NGL recovery processes that use only a single distillation tower. As will be understood, the lower pressures of the NGL recovery process 50 reduces the load required by compressor 36, and advantageously reduces the operating cost of the NGL recovery process 50. Additionally, the lower pressures of the NGL recovery process 50 increases the “relative volatility” of various components to be separated throughout the NGL recovery process 50, which i) advantageously reduces the number of separation stages that are theoretically required to achieve sufficient separation, and ii) advantageously reduces the amount of energy required by refluxing and reboiling.

As will be appreciated, the use of two (2) distillation towers, namely the first distillation tower 110 and the second distillation tower 170, enables the NGL recovery process 50 to advantageously provide two (2) stages of rectification for absorbing C₄ and heavier hydrocarbons, as compared to conventional NGL recovery processes that have only a single stage of rectification provided by a only single distillation tower. As will be understood, the two (2) stages of rectification advantageously increase recovery of NGL, and also reduce the chilling and condensation loads required by the NGL recovery process 50, as compared to conventional approaches.

As will be appreciated, the use of two (2) distillation towers, namely the first distillation tower 110 and the second distillation tower 170, divides the overall reflux duty and thereby allows lower reflux rates to be used. As will be understood, the lower reflux rates enable the first distillation tower 110 and the second distillation tower 170 to be smaller in diameter, which advantageously allows the towers 110 and 170 to be operated with lower refrigeration and heat medium loads, as compared to conventional NGL recovery processes that use only a single distillation tower.

As will be understood, the use of a single reflux system, namely heat exchanger 122 and separator 132, to generate two (2) reflux streams, namely the first pressurized second liquid fraction stream 144 and the second pressurized second liquid fraction stream 146, eliminates the need to provide an additional reflux system on the second distillation tower 170, and thereby advantageously reduces the capital expenditure required for the NGL recovery process 50.

As will be appreciated, the subcooling of the refrigerant liquid stream 166 as it transfers heat to the regulated pressurized first liquid fraction stream 162 in the heat exchanger 164, as well as the partial vaporization of the regulated pressurized first liquid fraction stream 162, advantageously result in a significant reduction in energy usage (and consequently in a significant increase in energy efficiency) as compared to what would otherwise be achieved if the heat exchanger 164 and the closed loop refrigerant system cooled by the mechanical refrigeration unit 128 were not used.

As will be appreciated, the heat exchanger 164 advantageously increases the distillation efficiency for separation of CO₂, methane and ethane entrained in the first liquid fraction stream 114 by feeding the second distillation tower 170 with a heated and partially vaporized two-phase stream 168. As will be understood, the heated and partially vaporized two-phase stream 168 reduces the heating load required by the heat medium system 192, as will as the associated utility requirements, and reduces the stripping load in the second distillation tower 170. These reductions advantageously result in reduced C₄ loss to vapor fraction stream 172, and thereby increase the C₄ yield in the NGL rich stream 52.

As will be appreciated, the first distillation tower 110 is used without a reboiler, which allows any trace amounts of water in the cold carbon dioxide recycle stream 106 to advantageously exit with the first liquid fraction stream 114. This water then enters the second distillation tower 170, which operates with a higher overhead temperature as compared to the first distillation tower 110, with the two-phase stream 168. As a result of the higher overhead temperature, the water advantageously exits with the third vapor fraction stream 172. In contrast, in conventional NGL recovery processes that use a single distillation tower, or that use multiple towers where the first tower has an associated reboiler and an associated condenser, water enters the single distillation tower with the feed stream at a mid-tower feed point, but otherwise has no way to exit. As will be understood, in such conventional NGL recovery processes, the condenser returns the water from the overhead back to the tower as reflux, and the reboiler returns water back to the tower as vapor in the stripping gas. This causes water to accumulate in the tower, which eventually disrupts the distillation process, and necessitates an additional separation or drying process to remove the water. The additional separation or drying process results in loss of NGL product, which lowers NGL yield of the conventional NGL recovery process.

As will be understood, operating conditions of the NGL recovery process 50 can be adjusted or “tuned” to vary one or more of the efficiency of the NGL recovery process 50, the composition of the dioxide recycle stream 54, and the composition of the NGL rich stream 52. For example, increasing the operating pressure of the second distillation tower 170 relative to the operating pressure of the first distillation tower 110 will result in the first liquid fraction stream 114 being boosted to a higher pressure by the bottoms pump 156, which in turn will increase the amount of flash cooling that occurs at valve 160. As will be appreciated, the increased flash cooling decreases the net refrigeration load on the refrigerant system cooled by the mechanical refrigeration unit 128, which advantageously further improves the efficiency of the NGL recovery process 50. Additionally, increasing the operating pressure of the second distillation tower 170 relative to the operating pressure of the first distillation tower 110 will advantageously also increase the yield of the NGL rich stream 52.

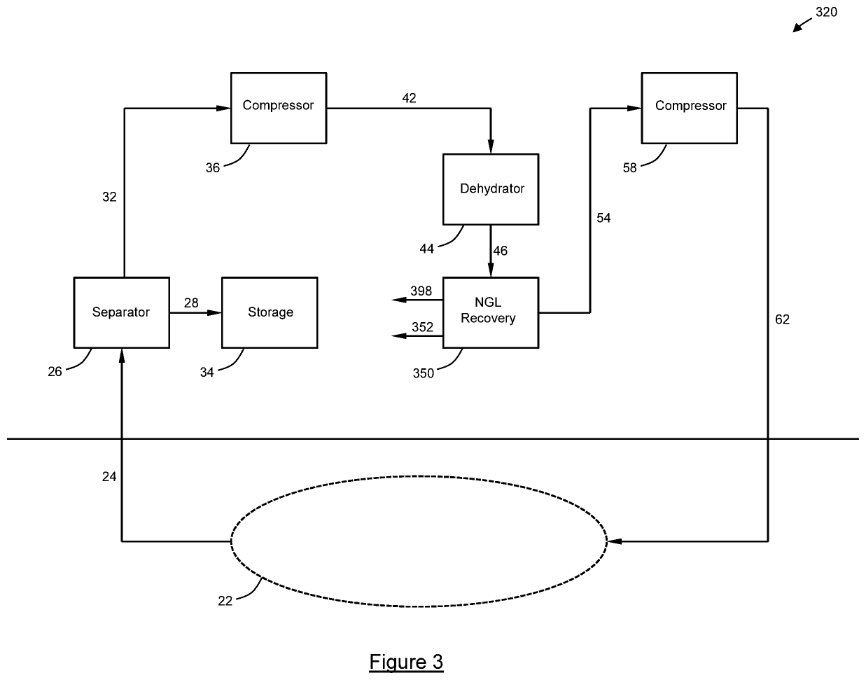

In other embodiments, other configurations are possible. For example, FIG. 3 shows another embodiment of a carbon dioxide reinjection process, which is generally indicated by reference numeral 320. Carbon dioxide reinjection process 320 is generally similar to carbon dioxide reinjection process 20 described above and with reference to FIG. 1, and is configured to receive hydrocarbons and carbon dioxide from an underground hydrocarbon reservoir 22, separate heavy hydrocarbons and some of the natural gas liquids (NGL) from the carbon dioxide, and reinject a portion of the carbon dioxide into the underground hydrocarbon reservoir 22 for continued recovery.

The carbon dioxide reinjection process 320 comprises the separator 26, the compressor 36 and the dehydrator 44 that yields the dehydrated carbon dioxide recycle stream 46, as described above and with reference to FIG. 1. However, in the carbon dioxide reinjection process 320, the dehydrated carbon dioxide recycle stream 46 is fed to an NGL recovery process 350, described below, which is configured to separate the dehydrated carbon dioxide recycle stream 46 into an NGL rich stream 352 and a propane rich stream 398, in addition to the purified carbon dioxide recycle stream 54.

The carbon dioxide reinjection process 320 also comprises the compressor 58, that yields the carbon dioxide injection stream 62, which is then injected downhole into the underground hydrocarbon reservoir 22 or alternatively may be sent to a carbon dioxide pipeline (not shown) or to storage (not shown), as described above and with reference to FIG. 1.

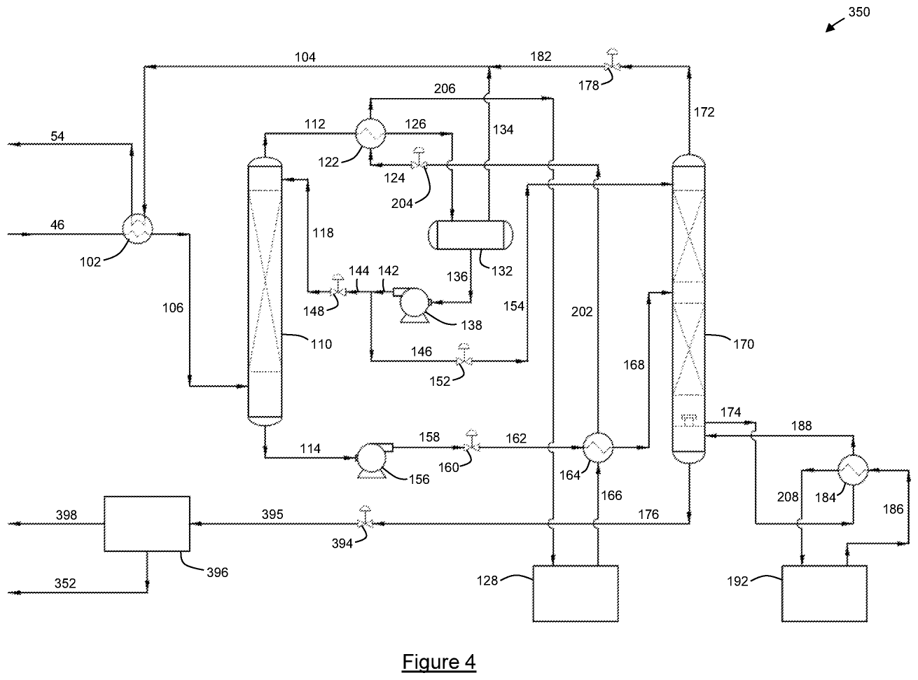

FIG. 4 shows the NGL recovery process 350. NGL recovery process 350 is generally similar to NGL recovery process 50 described above and with reference to FIG. 2. The NGL recovery process 350 begins with the dehydrated carbon dioxide recycle stream 46 being passed through the heat exchanger 102, with components then subsequently being passed through the first distillation tower 110, the heat exchanger 122, the separator 132, the reflux pump 138, the valves 148 and 152, the bottoms pump 156, the valve 160, the exchanger 164, the second distillation tower 170, the valve 178, and the heat exchanger 184, to yield the third liquid fraction stream 176, as described above for NGL recovery process 50. However, in this embodiment, certain operating conditions, including at least the operating conditions of the second distillation tower 170, are modified to yield a third liquid fraction stream 176 that has a higher propane content than what is otherwise achieved under the normal operating conditions of NGL recovery process 50. More specifically, in this embodiment, the temperature of the bottom section of the second distillation tower 170 is lowered from the temperature used for NGL recovery process 50, which increases the propane content of the third liquid fraction stream 176.

The third liquid fraction stream 176 is fed through a valve 394, which is configured to limit the flow of the third liquid fraction stream 176 by a desired amount to yield a regulated third liquid fraction stream 395. The regulated third liquid fraction stream 395 then enters a depropanizer 396, which is configured separate propane from the regulated third liquid fraction stream 395 to yield a NGL rich stream 352 and a propane rich stream 398 by fractionation. In this embodiment, the depropanizer 396 comprises a distillation column (not shown) comprising a packed bed, and an overhead condenser circuit (not shown) configured to condense and separate the overhead gas of the distillation column into a distillation reflux stream of cold reflux liquids, and the propane rich stream 398. During operation, the regulated third liquid fraction stream 395 mixes with liquids of the packed bed and yields a vapor fraction and a liquid fraction. The vapor fraction flows up through the packed bed, where it is counter-current contacted with cold reflux liquids, resulting in transfer of additional C₄₊ hydrocarbons from the vapor fraction to the liquid phase in which they are absorbed. The overhead gas, namely the vapor fraction reaching the top of the packed bed, exits the top of the distillation tower and enters the overhead condenser circuit, where it is cooled and separated into the distillation reflux stream and the propane rich stream 398. The liquids exit the bottom of the distillation tower as the NGL rich stream 352.

The NGL rich stream 352 comprises a majority of the butane, and substantially all of the pentane and heavier hydrocarbons, from the dehydrated carbon dioxide recycle stream 46. Additionally, the NGL rich stream 352 comprises only an insignificant portion of the propane from the dehydrated carbon dioxide recycle stream 46. The propane rich stream 398 comprises a majority of the propane from the dehydrated carbon dioxide recycle stream 46. Additionally, the propane rich stream 398 comprises only an insignificant portion of the butane, and substantially none of the pentane and heavier hydrocarbons, from the dehydrated carbon dioxide recycle stream 46. Additionally, in this embodiment, the third liquid fraction stream 176 preferably comprises an ethane/propane ratio of less than 5.0 molar percent, and more preferably comprises an ethane/propane ratio of less than 2.0 molar percent.

In other embodiments, the NGL recovery process 350 may further comprise an additional treatment unit (not shown) that is configured to remove traces of one or more of carbon dioxide, hydrogen sulfide, and sulphur compounds from the third liquid fraction stream 176. The additional treatment unit may be, for example, a separator comprising a solvent or a scavenger. In one such embodiment, the additional treatment unit may be located upstream from the depropanizer 396, such that the regulated third liquid fraction stream 395 is fed to the additional treatment unit. In another embodiment, the additional treatment unit may be located downstream from the 396, such that only the propane rich stream 398 is subjected to the additional treatment prior to exiting the NGL recovery process 350.

In other embodiments, the depropanizer 396 may further comprise a reboiler circuit (not shown) configured to heat the bottoms product of the distillation column.

Although in the embodiments described above, the first distillation tower is a refluxed absorber distillation column comprising a packed bed mass transfer section, in other embodiments, the first distillation tower may alternatively be a refluxed absorber distillation column comprising a trayed mass transfer section having one or more trays.

The following examples illustrate applications of the above-described embodiments.

### Example 1

In this example, a simulation of the NGL recovery process 50 was carried out using the using the VMG Symmetry Version 7.6 software package. Values of the composition, the temperature, and the pressure of the dehydrated carbon dioxide recycle stream 46 were input values. The physical data of various streams is provided in Tables 1A to 1H, and the chemical data of various streams is provided in Tables 2A to 2F, in which values are expressed in molar percentages and are rounded to three (3) decimal places (the values for each of ethyl mercaptan, dimethyl sulfide, isopropyl mercaptan, tert-butyl mercaptan, n-propyl mercaptan, methyl ethyl disulfide, and sec-butyl mercaptan in the dehydrated carbon dioxide recycle stream 46 are 0.0005 or less, and are therefore insignificant and are not shown):

TABLE 1A

| | | | | Partially |
|---|---|---|---|---|
| | Dehydrated | | | condensed |
| | carbon | Cold carbon | First vapor | first vapor |
| | dioxide | dioxide | fraction | fraction |
| | recycle | recycle | stream | stream |
| | stream 46 | stream 106 | 112 | 126 |
| VapFrac | 1.00 | 1.00 | 1.00 | 0.78 |
| T [F] | 110.5 | 21.5 | −20.2 | −21.2 |
| P [psia] | 235.0 | 228.0 | 222.3 | 222.0 |
| MoleFlow [lbmol/h] | 2.745E+04 | 2.745E+04 | 2.934E+04 | 2.934E+04 |
| MassFlow [lb/h] | 1.177E+06 | 1.177E+06 | 1.251E+06 | 1.251E+06 |
| VolumeFlow [bbl/d] | 2.814E+06 | 2.302E+06 | 2.213E+06 | 1.748E+06 |
| StdLiqVolumeFlow | 1.053E+05 | 1.053E+05 | 1.108E+05 | 1.108E+05 |
| [bbl/d] | | | | |
| StdGasVolumeFlow | 250.0 | 250.0 | 267.2 | 267.2 |
| [MMSCFD] | | | | |
| Energy [Btu/h] | 1.124E+08 | 8.606E+07 | 7.935E+07 | 4.250E+07 |
| H [Btu/lbmol] | 4095.1 | 3135.3 | 2704.8 | 1.449E+03 |
| S [Btu/lbmol-F] | 31.6 | 29.8 | 28.6 | 25.7 |
| MolecularWeight | 42.9 | 42.9 | 42.7 | 42.7 |
| MassDensity [lb/ft³] | 1.8 | 2.2 | 2.4 | 3.1 |
| Cp [Btu/lbmol-F] | 10.5 | 10.6 | 10.5 | 12.9 |
| ThermalConductivity | 0.012 | 0.010 | 0.009 | 0.024 |
| [Btu/h-ft-F] | | | | |
| Viscosity [cP] | 0.016 | 0.014 | 0.013 | 0.027 |
| molarV [ft³/lbmol] | 23.987 | 19.616 | 17.649 | 13.936 |
| ZFactor | 0.923 | 0.868 | 0.834 | 0.659 |

TABLE 1B

| | | | | First |
|---|---|---|---|---|
| | | | Pressurized | pressurized |
| | Second vapor | Second liquid | second liquid | second liquid |
| | fraction | fraction | fraction | fraction |
| | stream | stream | stream | stream |
| | 134 | 136 | 142 | 144 |
| VapFrac | 1.00 | 0.00 | 0.00 | 0.00 |
| T [F] | −21.6 | −21.2 | −20.7 | −20.7 |
| P [psia] | 220.0 | 222.0 | 272.0 | 272.0 |
| MoleFlow [lbmol/h] | 2.291E+04 | 6.428E+03 | 6.428E+03 | 5.678E+03 |
| MassFlow [lb/h] | 9.702E+05 | 2.811E+05 | 2.811E+05 | 2.483E+05 |
| VolumeFlow [bbl/d] | 1.746E+06 | 1.837E+04 | 1.837E+04 | 1.622E+04 |
| StdLiqVolumeFlow | 8.668E+04 | 2.416E+04 | 2.416E+04 | 2.134E+04 |
| [bbl/d] | | | | |
| StdGasVolumeFlow | 208.6 | 58.5 | 58.5 | 51.7 |
| [MMSCFD] | | | | |
| Energy [Btu/h] | 6.188E+07 | −1.938E+07 | −1.932E+07 | −1.707E+07 |
| H [Btu/lbmol] | 2.701E+03 | −3.015E+03 | −3.006E+03 | −3.006E+03 |
| S [Btu/lbmol-F] | 28.8 | 15.1 | 15.1 | 15.1 |
| MolecularWeight | 42.4 | 43.7 | 43.7 | 43.7 |
| MassDensity [lb/ft³] | 2.4 | 65.4 | 65.4 | 65.4 |
| Cp [Btu/lbmol-F] | 10.4 | 21.6 | 21.6 | 21.6 |
| ThermalConductivity | 0.009 | 0.078 | 0.078 | 0.078 |
| [Btu/h-ft-F] | | | | |
| Viscosity [cP] | 0.013 | 0.167 | 0.167 | 0.167 |
| molarV [ft³/lbmol] | 17.829 | 0.669 | 0.668 | 0.668 |
| ZFactor | 0.837 | 0.031 | 0.038 | 0.038 |

TABLE 1C

| | | | Pressurized | Regulated |
|---|---|---|---|---|
| | | First liquid | first liquid | first liquid |
| | Cold reflux | fraction | fraction | fraction |
| | liquids stream | stream | stream | stream |
| | 118 | 114 | 158 | 162 |
| VapFrac | 0.00 | 0.00 | 0.00 | 0.00 |
| T [F] | −20.8 | −15.8 | −15.2 | −15.3 |
| P [psia] | 240.0 | 226.0 | 276.0 | 256.0 |
| MoleFlow [lbmol/h] | 5.678E+03 | 3.792E+03 | 3.792E+03 | 3.792E+03 |
| MassFlow [lb/h] | 2.483E+05 | 1.738E+05 | 1.738E+05 | 1.738E+05 |
| VolumeFlow [bbl/d] | 1.624E+04 | 1.309E+04 | 1.309E+04 | 1.309E+04 |
| StdLiqVolumeFlow | 2.134E+04 | 1.582E+04 | 1.582E+04 | 1.582E+04 |
| [bbl/d] | | | | |
| StdGasVolumeFlow | 51.7 | 34.5 | 34.5 | 34.5 |
| [MMSCFD] | | | | |
| Energy [Btu/h] | −1.707E+07 | −1.040E+07 | −1.036E+07 | −1.036E+07 |
| H [Btu/lbmol] | −3.006E+03 | −2.744E+03 | −2.733E+03 | −2.733E+03 |
| S [Btu/lbmol-F] | 15.1 | 18.0 | 18.0 | 18.0 |
| MolecularWeight | 43.7 | 45.8 | 45.8 | 45.8 |
| MassDensity [lb/ft³] | 65.4 | 56.8 | 56.8 | 56.7 |
| Cp [Btu/lbmol-F] | 21.6 | 22.8 | 22.8 | 22.8 |
| ThermalConductivity | 0.078 | 0.067 | 0.067 | 0.067 |
| [Btu/h-ft-F] | | | | |
| Viscosity [cP] | 0.167 | 0.183 | 0.183 | 0.183 |
| molarV [ft³/lbmol] | 0.669 | 0.808 | 0.807 | 0.808 |
| ZFactor | 0.034 | 0.038 | 0.046 | 0.043 |

TABLE 1D

| | | Second | | |
|---|---|---|---|---|
| | | pressurized | | |
| | | second liquid | Second cold | Third vapor |
| | Two-phase | fraction | reflux liquids | fraction |
| | stream | stream | stream | stream |
| | 168 | 146 | 154 | 172 |
| VapFrac | 0.81 | 0.00 | 0.00 | 1.00 |
| T [F] | 12.3 | −20.7 | −20.8 | −11.8 |
| P [psia] | 251.0 | 272.0 | 250.0 | 235.0 |
| MoleFlow [lbmol/h] | 3.792E+03 | 7.500E+02 | 7.500E+02 | 4.206E+03 |
| MassFlow [lb/h] | 1.738E+05 | 3.279E+04 | 3.279E+04 | 1.834E+05 |
| VolumeFlow [bbl/d] | 2.254E+05 | 2.143E+03 | 2.144E+03 | 3.006E+05 |
| StdLiqVolumeFlow | 1.582E+04 | 2.819E+03 | 2.819E+03 | 1.607E+04 |
| [bbl/d] | | | | |
| StdGasVolumeFlow | 34.5 | 6.8 | 6.8 | 38.3 |
| [MMSCFD] | | | | |
| Energy [Btu/h] | 7.420E+06 | −2.254E+06 | −2.254E+06 | 1.168E+07 |
| H [Btu/lbmol] | 1.957E+03 | −3.006E+03 | −3.006E+03 | 2.776E+03 |
| S [Btu/lbmol-F] | 28.3 | 15.1 | 15.1 | 28.6 |
| MolecularWeight | 45.8 | 43.7 | 43.7 | 43.6 |
| MassDensity [lb/ft³] | 3.3 | 65.4 | 65.4 | 2.6 |
| Cp [Btu/lbmol-F] | 14.3 | 21.6 | 21.6 | 11.0 |
| ThermalConductivity | 0.021 | 0.078 | 0.078 | 0.009 |
| [Btu/h-ft-F] | | | | |
| Viscosity [cP] | 0.026 | 0.167 | 0.167 | 0.013 |
| molarV [ft³/lbmol] | 13.908 | 0.668 | 0.669 | 16.722 |
| ZFactor | 0.691 | 0.038 | 0.035 | 0.820 |

TABLE 1E

| | Regulated | | Residual | |
|---|---|---|---|---|
| | third vapor | Combined | carbon | Intermediate |
| | fraction | Carbon | dioxide | liquid fraction |
| | stream | dioxide | recycle | stream |
| | 182 | stream 104 | stream 54 | 174 |
| VapFrac | 1.00 | 1.00 | 1.00 | 0.00 |
| T [F] | −15.1 | −20.6 | 73.4 | 233.1 |
| P [psia] | 220.0 | 220.0 | 214.0 | 238.8 |
| MoleFlow [lbmol/h] | 4.206E+03 | 2.711E+04 | 2.711E+04 | 1.478E+03 |
| MassFlow [lb/h] | 1.834E+05 | 1.154E+06 | 1.154E+06 | 9.450E+04 |
| VolumeFlow [bbl/d] | 3.225E+05 | 2.068E+06 | 2.833E+06 | 1.356E+04 |
| StdLiqVolumeFlow | 1.607E+04 | 1.027E+05 | 1.027E+05 | 1.077E+04 |
| [bbl/d] | | | | |
| StdGasVolumeFlow | 38.3 | 246.9 | 246.9 | 13.5 |
| [MMSCFD] | | | | |
| Energy [Btu/h] | 1.168E+07 | 7.356E+07 | 9.991E+07 | 7.114E+06 |
| H [Btu/lbmol] | 2.776E+03 | 2.713E+03 | 3.685E+03 | 4.813E+03 |
| S [Btu/lbmol-F] | 28.7 | 28.8 | 30.8 | 39.6 |
| MolecularWeight | 43.6 | 42.5 | 42.5 | 63.9 |
| MassDensity [lb/ft³] | 2.4 | 2.4 | 1.7 | 29.8 |
| Cp [Btu/lbmol-F] | 10.8 | 10.5 | 10.1 | 50.1 |
| ThermalConductivity | 0.008 | 0.009 | 0.011 | 0.042 |
| [Btu/h-ft-F] | | | | |
| Viscosity [cP] | 0.013 | 0.013 | 0.015 | 0.079 |
| molarV [ft³/lbmol] | 17.935 | 17.846 | 24.444 | 2.146 |
| ZFactor | 0.829 | 0.836 | 0.916 | 0.070 |

TABLE IF

| | Partially | | Regulated | |
|---|---|---|---|---|
| | vaporized | Third liquid | third liquid | |
| | intermediate | fraction | fraction | NGL rich |
| | stream | stream | stream | stream |
| Stream | 188 | 176 | 196 | 52 |
| VapFrac | 0.77 | 0.00 | 0.02 | 0.00 |
| T [F] | 255.2 | 255.2 | 253.3 | 115.0 |
| P [psia] | 239.0 | 239.0 | 234.0 | 229.0 |
| MoleFlow [lbmol/h] | 1.478E+03 | 3.359E+02 | 3.359E+02 | 3.359E+02 |
| MassFlow [lb/h] | 9.450E+04 | 2.321E+04 | 2.321E+04 | 2.321E+04 |
| VolumeFlow [bbl/d] | 1.164E+05 | 3.263E+03 | 3.731E+03 | 2.678E+03 |
| StdLiqVolumeFlow | 1.077E+04 | 2.574E+03 | 2.574E+03 | 2.574E+03 |
| [bbl/d] | | | | |
| StdGasVolumeFlow | 13.5 | 3.1 | 3.1 | 3.1 |
| [MMSCFD] | | | | |
| Energy [Btu/h] | 1.566E+07 | 2.032E+06 | 2.032E+06 | -1.486E+05 |
| H [Btu/lbmol] | 1.059E+04 | 6.051E+03 | 6.051E+03 | -4.424E+02 |
| S [Btu/lbmol-F] | 47.8 | 45.1 | 45.1 | 35.0 |
| MolecularWeight | 63.9 | 69.1 | 69.1 | 69.1 |
| MassDensity [lb/ft³] | 3.5 | 30.4 | 26.6 | 37.1 |
| Cp [Btu/lbmol-F] | 40.4 | 53.3 | 52.8 | 41.5 |
| ThermalConductivity | 0.023 | 0.042 | 0.042 | 0.070 |
| [Btu/h-ft-F] | | | | |
| Viscosity [cP] | 0.018 | 0.083 | 0.082 | 0.164 |
| molarV [ft³/lbmol] | 18.422 | 2.273 | 2.599 | 1.865 |
| ZFactor | 0.579 | 0.073 | 0.081 | 0.068 |

TABLE 1G

| | | | Partially | |
|---|---|---|---|---|
| | | | vaporized | |
| | | Sub-cooled | cold | |
| | Refrigerant | refrigerant | refrigerant | Refrigerant |
| | liquid stream | liquid stream | liquid stream | vapor stream |
| | 166 | 202 | 124 | 206 |
| VapFrac | 0.00 | 0.00 | 0.13 | 1.00 |
| T [F] | 120.0 | 5.0 | −33.6 | −31.9 |
| P [psia] | 250.5 | 250.5 | 19.5 | 19.0 |
| MoleFlow [lbmol/h] | 5.244E+03 | 5.244E+03 | 5.244E+03 | 5.244E+03 |
| MassFlow [lb/h] | 2.309E+05 | 2.309E+05 | 2.309E+05 | 2.309E+05 |
| VolumeFlow [bbl/d] | 3.502E+04 | 2.849E+04 | 6.593E+05 | 5.197E+06 |
| StdLiqVolumeFlow | 3.142E+04 | 3.142E+04 | 3.142E+04 | 3.142E+04 |
| [bbl/d] | | | | |
| StdGasVolumeFlow | 47.8 | 47.8 | 47.8 | 47.8 |
| [MMSCFD] | | | | |
| Energy [Btu/h] | 4.542E+06 | −1.324E+07 | −1.324E+07 | 2.360E+07 |
| H [Btu/lbmol] | 8.661E+02 | −2.525E+03 | −2.525E+03 | 4.501E+03 |
| S [Btu/lbmol-F] | 33.9 | 27.4 | 27.6 | 44.1 |
| MolecularWeight | 44.0 | 44.0 | 44.0 | 44.0 |
| MassDensity [lb/ft³] | 28.2 | 34.6 | 1.5 | 0.2 |
| Cp [Btu/lbmol-F] | 35.6 | 25.9 | 23.4 | 15.6 |
| ThermalConductivity | 0.045 | 0.069 | 0.068 | 0.007 |
| [Btu/h-ft-F] | | | | |
| Viscosity [cP] | 0.076 | 0.156 | 0.144 | 0.007 |
| molarV [ft³/lbmol] | 1.562 | 1.271 | 29.413 | 231.854 |
| ZFactor | 0.063 | 0.060 | 0.125 | 0.960 |

TABLE III

| | | Cooled heat |
|---|---|---|
| | Heat medium | medium |
| | stream | stream |
| Stream | 186 | 208 |
| VapFrac | 0.00 | 0.00 |
| T [F] | 350.0 | 300.0 |
| P [psia] | 90.0 | 85.0 |
| MoleFlow [lbmol/h] | 1.056E+03 | 1.056E+03 |
| MassFlow [lb/h] | 3.380E+05 | 3.380E+05 |
| VolumeFlow [bbl/d] | 2.849E+04 | 2.807E+04 |
| StdLiqVolumeFlow | 2.657E+04 | 2.657E+04 |
| [bbl/d] | | |
| StdGasVolumeFlow | 9.6 | 9.6 |
| [MMSCFD] | | |
| Energy [Btu/h] | 5.622E+07 | 4.768E+07 |
| H [Btu/lbmol] | 5.323E+04 | 4.514E+04 |
| S [Btu/lbmol-F] | 239.6 | 229.3 |
| MolecularWeight | 320.0 | 320.0 |
| MassDensity [lb/ft³] | 50.7 | 51.5 |
| Cp [Btu/lbmol-F] | 165.9 | 157.4 |
| ThermalConductivity | 0.063 | 0.064 |
| [Btu/h-ft-F] | | |
| Viscosity [cP] | 0.947 | 1.293 |
| molarV [ft³/lbmol] | 6.311 | 6.216 |
| ZFactor | 0.073 | 0.072 |

TABLE2A

| | | | | Partially |
|---|---|---|---|---|
| | Dehydrated | | | condensed |
| | carbon | Cold carbon | First vapor | first vapor |
| | dioxide | dioxide | fraction | fraction |
| | recycle stream | recycle | stream | stream |
| | 46 | stream 106 | 112 | 126 |
| Hydrogen | 0.0901 | 0.0901 | 0.0843 | 0.084 |
| Nitrogen | 0.8906 | 0.8906 | 0.8359 | 0.836 |
| Carbon | 89.9015 | 89.9015 | 91.8279 | 91.828 |
| dioxide | | | | |
| Hydrogen | 0.9006 | 0.9006 | 0.8810 | 0.881 |
| sulfide | | | | |
| Methane | 3.2722 | 3.2722 | 3.0713 | 3.071 |
| Ethane | 1.9513 | 1.9513 | 1.8352 | 1.835 |
| Propane | 1.6912 | 1.6912 | 1.3515 | 1.351 |
| Isobutane | 0.2201 | 0.2201 | 0.0660 | 0.066 |
| n-Butane | 0.5304 | 0.5304 | 0.0430 | 0.043 |
| Isopentane | 0.1401 | 0.1401 | 0.0000 | 0.000 |
| n-Pentane | 0.1401 | 0.1401 | 0.0000 | 0.000 |
| n-Hexane | 0.1101 | 0.1101 | 0.0000 | 0.000 |
| n-Heptane | 0.1000 | 0.1000 | 0.0000 | 0.000 |
| n-Octane | 0.0300 | 0.0300 | 0.0000 | 0.000 |
| n-Nonane | 0.0100 | 0.0100 | 0.0000 | 0.000 |
| Water | 0.0000 | 0.0000 | 0.0000 | 0.000 |
| Triethylene | 0.0000 | 0.0000 | 0.0000 | 0.000 |
| glycol | | | | |
| Carbonyl | 0.0153 | 0.0153 | 0.0039 | 0.004 |
| sulfide | | | | |
| Methyl | 0.0055 | 0.0055 | 0.0000 | 0.000 |
| mercaptan | | | | |

TABLE 2B

| | | | | First |
|---|---|---|---|---|
| | | Second | Pressurized | pressurized |
| | Second vapor | liquid | second liquid | second liquid |
| | fraction | fraction | fraction | fraction |
| | stream | stream | stream | stream |
| | 134 | 136 | 142 | 144 |
| Hydrogen | 0.108 | 0.000 | 0.000 | 0.000 |
| Nitrogen | 1.060 | 0.037 | 0.037 | 0.037 |
| Carbon | 90.832 | 95.376 | 95.376 | 95.376 |
| dioxide | | | | |
| Hydrogen | 0.817 | 1.110 | 1.110 | 1.110 |
| sulfide | | | | |
| Methane | 3.850 | 0.296 | 0.296 | 0.296 |
| Ethane | 2.101 | 0.886 | 0.886 | 0.886 |
| Propane | 1.162 | 2.028 | 2.028 | 2.028 |
| Isobutane | 0.043 | 0.147 | 0.147 | 0.147 |
| n-Butane | 0.024 | 0.109 | 0.109 | 0.109 |
| Isopentane | 0.000 | 0.000 | 0.000 | 0.000 |
| n-Pentane | 0.000 | 0.000 | 0.000 | 0.000 |
| n-Hexane | 0.000 | 0.000 | 0.000 | 0.000 |
| n-Heptane | 0.000 | 0.000 | 0.000 | 0.000 |
| n-Octane | 0.000 | 0.000 | 0.000 | 0.000 |
| n-Nonane | 0.000 | 0.000 | 0.000 | 0.000 |
| Water | 0.000 | 0.000 | 0.000 | 0.000 |
| Triethylene | 0.000 | 0.000 | 0.000 | 0.000 |
| glycol | | | | |
| Carbonyl | 0.002 | 0.010 | 0.010 | 0.010 |
| sulfide | | | | |
| Methyl | 0.000 | 0.000 | 0.000 | 0.000 |
| mercaptan | | | | |

TABLE 2C

| | | | Pressurized | Regulated |
|---|---|---|---|---|
| | | First liquid | first liquid | first liquid |
| | Cold reflux | fraction | fraction | fraction |
| | liquids stream | stream | stream | stream |
| | 118 | 114 | 158 | 162 |
| Hydrogen | 0.000 | 0.000 | 0.000 | 0.000 |
| Nitrogen | 0.037 | 0.036 | 0.036 | 0.036 |
| Carbon | 95.376 | 83.196 | 83.196 | 83.196 |
| dioxide | | | | |
| Hydrogen | 1.110 | 1.365 | 1.365 | 1.365 |
| sulfide | | | | |
| Methane | 0.296 | 0.370 | 0.370 | 0.370 |
| Ethane | 0.886 | 1.255 | 1.255 | 1.255 |
| Propane | 2.028 | 4.823 | 4.823 | 4.823 |
| Isobutane | 0.147 | 1.304 | 1.304 | 1.304 |
| n-Butane | 0.109 | 3.670 | 3.670 | 3.670 |
| Isopentane | 0.000 | 1.014 | 1.014 | 1.014 |
| n-Pentane | 0.000 | 1.014 | 1.014 | 1.014 |
| n-Hexane | 0.000 | 0.797 | 0.797 | 0.797 |
| n-Heptane | 0.000 | 0.724 | 0.724 | 0.724 |
| n-Octane | 0.000 | 0.217 | 0.217 | 0.217 |
| n-Nonane | 0.000 | 0.072 | 0.072 | 0.072 |
| Water | 0.000 | 0.000 | 0.000 | 0.000 |
| Triethylene | 0.000 | 0.000 | 0.000 | 0.000 |
| glycol | | | | |
| Carbonyl | 0.010 | 0.096 | 0.096 | 0.096 |
| sulfide | | | | |
| Methyl | 0.000 | 0.040 | 0.040 | 0.040 |
| mercaptan | | | | |

TABLE 2D

| | | Second | | |
|---|---|---|---|---|
| | | pressurized | | |
| | | second liquid | Second cold | Third vapor |
| | Two-phase | fraction | reflux liquids | fraction |
| | stream | stream | stream | stream |
| | 168 | 146 | 154 | 172 |
| Hydrogen | 0.000 | 0.000 | 0.000 | 0.000 |
| Nitrogen | 0.036 | 0.037 | 0.037 | 0.039 |
| Carbon | 83.196 | 95.376 | 95.376 | 92.011 |
| dioxide | | | | |
| Hydrogen | 1.365 | 1.110 | 1.110 | 1.429 |
| sulfide | | | | |
| Methane | 0.370 | 0.296 | 0.296 | 0.386 |
| Ethane | 1.255 | 0.886 | 0.886 | 1.290 |
| Propane | 4.823 | 2.028 | 2.028 | 4.659 |
| Isobutane | 1.304 | 0.147 | 0.147 | 0.072 |
| n-Butane | 3.670 | 0.109 | 0.109 | 0.026 |
| Isopentane | 1.014 | 0.000 | 0.000 | 0.000 |
| n-Pentane | 1.014 | 0.000 | 0.000 | 0.000 |
| n-Hexane | 0.797 | 0.000 | 0.000 | 0.000 |
| n-Heptane | 0.724 | 0.000 | 0.000 | 0.000 |
| n-Octane | 0.217 | 0.000 | 0.000 | 0.000 |
| n-Nonane | 0.072 | 0.000 | 0.000 | 0.000 |
| Water | 0.000 | 0.000 | 0.000 | 0.000 |
| Triethylene | 0.000 | 0.000 | 0.000 | 0.000 |
| glycol | | | | |
| Carbonyl | 0.096 | 0.010 | 0.010 | 0.088 |
| sulfide | | | | |
| Methyl | 0.040 | 0.000 | 0.000 | 0.000 |
| mercaptan | | | | |

TABLE 2E

| | Regulated | | Residual | |
|---|---|---|---|---|
| | third | Combined | carbon | Intermediate |
| | vapor fraction | carbon | dioxide | liquid fraction |
| | stream | dioxide | recycle | stream |
| | 182 | stream 104 | stream 54 | 174 |
| Hydrogen | 0.000 | 0.091 | 0.091 | 0.000 |
| Nitrogen | 0.039 | 0.902 | 0.902 | 0.000 |
| Carbon | 92.011 | 91.015 | 91.015 | 0.000 |
| dioxide | | | | |
| Hydrogen | 1.429 | 0.912 | 0.912 | 0.000 |
| sulfide | | | | |
| Methane | 0.386 | 3.313 | 3.313 | 0.000 |
| Ethane | 1.290 | 1.976 | 1.976 | 0.000 |
| Propane | 4.659 | 1.704 | 1.704 | 1.317 |
| Isobutane | 0.072 | 0.048 | 0.048 | 19.496 |
| n-Butane | 0.026 | 0.025 | 0.025 | 50.227 |
| Isopentane | 0.000 | 0.000 | 0.000 | 9.737 |
| n-Pentane | 0.000 | 0.000 | 0.000 | 9.198 |
| n-Hexane | 0.000 | 0.000 | 0.000 | 4.853 |
| n-Heptane | 0.000 | 0.000 | 0.000 | 3.365 |
| n-Octane | 0.000 | 0.000 | 0.000 | 0.818 |
| n-Nonane | 0.000 | 0.000 | 0.000 | 0.236 |
| Water | 0.000 | 0.000 | 0.000 | 0.000 |
| Triethylene | 0.000 | 0.000 | 0.000 | 0.000 |
| glycol | | | | |
| Carbonyl | 0.088 | 0.015 | 0.015 | 0.003 |
| sulfide | | | | |
| Methyl | 0.000 | 0.000 | 0.000 | 0.685 |
| mercaptan | | | | |

TABLE 2F

| | Partially | | Regulated | |
|---|---|---|---|---|
| | vaporized | Third liquid | third liquid | |
| | intermediate | fraction | fraction | NGL rich |
| | stream | stream | stream | stream |
| | 188 | 176 | 196 | 52 |
| Hydrogen | 0.000 | 0.000 | 0.000 | 0.000 |
| Nitrogen | 0.000 | 0.000 | 0.000 | 0.000 |
| Carbon | 0.000 | 0.000 | 0.000 | 0.000 |
| dioxide | | | | |
| Hydrogen | 0.000 | 0.000 | 0.000 | 0.000 |
| sulfide | | | | |
| Methane | 0.000 | 0.000 | 0.000 | 0.000 |
| Ethane | 0.000 | 0.000 | 0.000 | 0.000 |
| Propane | 1.317 | 0.640 | 0.640 | 0.640 |
| Isobutane | 19.496 | 14.144 | 14.144 | 14.144 |
| n-Butane | 50.227 | 41.356 | 41.356 | 41.356 |
| Isopentane | 9.737 | 11.449 | 11.449 | 11.449 |
| n-Pentane | 9.198 | 11.449 | 11.449 | 11.449 |
| n-Hexane | 4.853 | 8.995 | 8.995 | 8.995 |
| n-Heptane | 3.365 | 8.175 | 8.175 | 8.175 |
| n-Octane | 0.818 | 2.450 | 2.450 | 2.450 |
| n-Nonane | 0.236 | 0.815 | 0.815 | 0.815 |
| Water | 0.000 | 0.000 | 0.000 | 0.000 |
| Triethylene | 0.000 | 0.000 | 0.000 | 0.000 |
| glycol | | | | |
| Carbonyl | 0.003 | 0.001 | 0.001 | 0.001 |
| sulfide | | | | |
| Methyl | 0.685 | 0.450 | 0.450 | 0.450 |
| mercaptan | | | | |

The recovery percentages for each of propane, isobutane, n-butane and C₅₊ for this example, calculated on a dry sweet basis, are provided in Table 3:

TABLE 3

| | Dehydrated | | |
|---|---|---|---|
| | carbon | First liquid | Third liquid |
| | dioxide | fraction | fraction |
| | recycle stream | stream | stream |
| | 46 | 114 | 176 |
| Propane | 100 | 39.4 | 0.5 |
| Isobutane | 100 | 81.8 | 78.6 |
| n-Butane | 100 | 95.6 | 95.4 |
| C₅₊ | 100 | 100 | 100 |

### Example 2

In this example, a simulation of the NGL recovery process 350 was carried out using the using the VMG Symmetry Version 7.6 software package. Values of the composition, the temperature, and the pressure of the dehydrated carbon dioxide recycle stream 46 were input values. The physical data of various streams is provided in Tables 4A to 4I, and the chemical data of various streams is provided in Tables 5A to 5G, in which values are expressed in molar percentages and are rounded to three (3) decimal places (the values for each of ethyl mercaptan, dimethyl sulfide, isopropyl mercaptan, tert-butyl mercaptan, n-propyl mercaptan, methyl ethyl disulfide, and sec-butyl mercaptan in the dehydrated carbon dioxide recycle stream 46 are 0.0005 or less, and are therefore insignificant and are not shown):

TABLE 4A

| | | | | Partially |
|---|---|---|---|---|
| | Dehydrated | | | condensed |
| | carbon | Cold carbon | First vapor | first vapor |
| | dioxide | dioxide | fraction | fraction |
| | recycle | recycle | stream | stream |
| | stream 46 | stream 106 | 112 | 126 |
| VapFrac | 1.00 | 1.00 | 1.00 | 0.78 |
| T [F] | 110.5 | 21.5 | −20.2 | −21.2 |
| P [psia] | 235.0 | 228.0 | 222.3 | 222.0 |
| MoleFlow [lbmol/h] | 2.745E+04 | 2.745E+04 | 2.934E+04 | 2.934E+04 |
| MassFlow [lb/h] | 1.177E+06 | 1.177E+06 | 1.251E+06 | 1.251E+06 |
| VolumeFlow [bbl/d] | 2.814E+06 | 2.302E+06 | 2.213E+06 | 1.748E+06 |
| StdLiqVolumeFlow | 1.053E+05 | 1.053E+05 | 1.108E+05 | 1.108E+05 |
| [bbl/d] | | | | |
| StdGasVolumeFlow | 250.0 | 250.0 | 267.2 | 267.2 |
| [MMSCFD] | | | | |
| Energy [Btu/h] | 1.124E+08 | 8.606E+07 | 7.935E+07 | 4.250E+07 |
| H [Btu/lbmol] | 4.095E+03 | 3.135E+03 | 2.705E+03 | 1.449E+03 |
| S [Btu/lbmol-F] | 31.6 | 29.8 | 28.6 | 25.7 |
| MolecularWeight | 42.9 | 42.9 | 42.7 | 42.7 |
| MassDensity [lb/ft³] | 1.8 | 2.2 | 2.4 | 3.1 |
| Cp [Btu/lbmol-F] | 10.5 | 10.6 | 10.5 | 12.9 |
| ThermalConductivity | 0.012 | 0.010 | 0.009 | 0.024 |
| [Btu/h-ft-F] | | | | |
| Viscosity [cP] | 0.016 | 0.014 | 0.013 | 0.027 |
| molarV [ft³/lbmol] | 23.987 | 19.616 | 17.649 | 13.936 |
| ZFactor | 0.923 | 0.868 | 0.834 | 0.659 |

TABLE 4B

| | | | | First |
|---|---|---|---|---|
| | | | Pressurized | pressurized |
| | Second vapor | Second liquid | second liquid | second liquid |
| | fraction | fraction | fraction | fraction |
| | stream | stream | stream | stream |
| | 134 | 136 | 142 | 144 |
| VapFrac | 1.00 | 0.00 | 0.00 | 0.00 |
| T [F] | −21.6 | −21.2 | −20.7 | −20.7 |
| P [psia] | 220.0 | 222.0 | 272.0 | 272.0 |
| MoleFlow [lbmol/h] | 2.291E+04 | 6.428E+03 | 6.428E+03 | 5.678E+03 |
| MassFlow [lb/h] | 9.702E+05 | 2.811E+05 | 2.811E+05 | 2.483E+05 |
| VolumeFlow [bbl/d] | 1.746E+06 | 1.837E+04 | 1.837E+04 | 1.622E+04 |
| StdLiqVolumeFlow | 8.668E+04 | 2.416E+04 | 2.416E+04 | 2.134E+04 |
| [bbl/d] | | | | |
| StdGasVolumeFlow | 208.6 | 58.5 | 58.5 | 51.7 |
| [MMSCFD] | | | | |
| Energy [Btu/h] | 6.188E+07 | −1.938E+07 | −1.932E+07 | −1.707E+07 |
| H [Btu/lbmol] | 2.701E+03 | −3.015E+03 | −3.006E+03 | −3.006E+03 |
| S [Btu/lbmol-F] | 28.8 | 15.1 | 15.1 | 15.1 |
| MolecularWeight | 42.4 | 43.7 | 43.7 | 43.7 |
| MassDensity [lb/ft³] | 2.4 | 65.4 | 65.4 | 65.4 |
| Cp [Btu/lbmol-F] | 10.4 | 21.6 | 21.6 | 21.6 |
| ThermalConductivity | 0.009 | 0.078 | 0.078 | 0.078 |
| [Btu/h-ft-F] | | | | |
| Viscosity [cP] | 0.013 | 0.167 | 0.167 | 0.167 |
| molarV [ft³/lbmol] | 17.829 | 0.669 | 0.668 | 0.668 |
| ZFactor | 0.837 | 0.031 | 0.038 | 0.038 |

TABLE 4C

| | | | Pressurized | Regulated |
|---|---|---|---|---|
| | | First liquid | first liquid | first liquid |
| | Cold reflux | fraction | fraction | fraction |
| | liquids stream | stream | stream | stream |
| | 118 | 114 | 158 | 162 |
| VapFrac | 0.00 | 0.00 | 0.00 | 0.00 |
| T [F] | −20.8 | −15.8 | −15.2 | −15.3 |
| P [psia] | 240.0 | 226.0 | 276.0 | 256.0 |
| MoleFlow [lbmol/h] | 5.678E+03 | 3.792E+03 | 3.792E+03 | 3.792E+03 |
| MassFlow [lb/h] | 2.483E+05 | 1.738E+05 | 1.738E+05 | 1.738E+05 |
| VolumeFlow [bbl/d] | 1.624E+04 | 1.309E+04 | 1.309E+04 | 1.309E+04 |
| StdLiqVolumeFlow | 2.134E+04 | 1.582E+04 | 1.582E+04 | 1.582E+04 |
| [bbl/d] | | | | |
| StdGasVolumeFlow | 51.7 | 34.5 | 34.5 | 34.5 |
| [MMSCFD] | | | | |
| Energy [Btu/h] | −1.707E+07 | −1.040E+07 | −1.036E+07 | −1.036E+07 |
| H [Btu/lbmol] | −3.006E+03 | −2.744E+03 | −2.733E+03 | −2.733E+03 |
| S [Btu/lbmol-F] | 15.1 | 18.0 | 18.0 | 18.0 |
| MolecularWeight | 43.7 | 45.8 | 45.8 | 45.8 |
| MassDensity [lb/ft³] | 65.4 | 56.8 | 56.8 | 56.7 |
| Cp [Btu/lbmol-F] | 21.6 | 22.8 | 22.8 | 22.8 |
| ThermalConductivity | 0.078 | 0.067 | 0.067 | 0.067 |
| [Btu/h-ft-F] | | | | |
| Viscosity [cP] | 0.167 | 0.183 | 0.183 | 0.183 |
| molarV [ft³/lbmol] | 0.669 | 0.808 | 0.807 | 0.808 |
| ZFactor | 0.034 | 0.038 | 0.046 | 0.043 |

TABLE 4D

| | | Second | | |
|---|---|---|---|---|
| | | pressurized | | |
| | | second liquid | Second cold | Third vapor |
| | Two-phase | fraction | reflux liquids | fraction |
| | stream | stream | stream | stream |
| | 168 | 146 | 154 | 172 |
| VapFrac | 0.81 | 0.00 | 0.00 | 1.00 |
| T [F] | 12.3 | −20.7 | −20.8 | −14.1 |
| P [psia] | 251.0 | 272.0 | 250.0 | 235.0 |
| MoleFlow [lbmol/h] | 3.792E+03 | 7.500E+02 | 7.500E+02 | 4.078E+03 |
| MassFlow [lb/h] | 1.738E+05 | 3.279E+04 | 3.279E+04 | 1.778E+05 |
| VolumeFlow [bbl/d] | 2.254E+05 | 2.143E+03 | 2.144E+03 | 2.909E+05 |
| StdLiqVolumeFlow | 1.582E+04 | 2.819E+03 | 2.819E+03 | 1.534E+04 |
| [bbl/d] | | | | |
| StdGasVolumeFlow | 34.5 | 6.8 | 6.8 | 37.1 |
| [MMSCFD] | | | | |
| Energy [Btu/h] | 7.420E+06 | −2.254E+06 | −2.254E+06 | 1.108E+07 |
| H [Btu/lbmol] | 1.957E+03 | −3.006E+03 | −3.006E+03 | 2.717E+03 |
| S [Btu/lbmol-F] | 28.3 | 15.1 | 15.1 | 28.0 |
| MolecularWeight | 45.8 | 43.7 | 43.7 | 43.6 |
| MassDensity [lb/ft³] | 3.3 | 65.4 | 65.4 | 2.6 |
| Cp [Btu/lbmol-F] | 14.3 | 21.6 | 21.6 | 10.8 |
| ThermalConductivity | 0.021 | 0.078 | 0.078 | 0.008 |
| [Btu/h-ft-F] | | | | |
| Viscosity [cP] | 0.026 | 0.167 | 0.167 | 0.013 |
| molarV [ft³/lbmol] | 13.908 | 0.668 | 0.669 | 16.684 |
| ZFactor | 0.691 | 0.038 | 0.035 | 0.823 |

TABLE 4E

| | Regulated | | Residual | |
|---|---|---|---|---|
| | third vapor | Combined | carbon | Intermediate |
| | fraction | Carbon | dioxide | liquid fraction |
| | stream | dioxide | recycle | stream |
| | 182 | stream 104 | stream 54 | 174 |
| VapFrac | 1.00 | 1.00 | 1.00 | 0.00 |
| T [F] | −17.4 | −21.0 | 73.8 | 156.5 |
| P [psia] | 220.0 | 220.0 | 214.0 | 238.8 |
| MoleFlow [lbmol/h] | 4.078E+03 | 2.699E+04 | 2.699E+04 | 1.401E+03 |
| MassFlow [lb/h] | 1.778E+05 | 1.148E+06 | 1.148E+06 | 7.724E+04 |
| VolumeFlow [bbl/d] | 3.119E+05 | 2.058E+06 | 2.824E+06 | 1.044E+04 |
| StdLiqVolumeFlow | 1.534E+04 | 1.020E+05 | 1.020E+05 | 9.185E+03 |
| [bbl/d] | | | | |
| StdGasVolumeFlow | 37.1 | 245.8 | 245.8 | 12.8 |
| [MMSCFD] | | | | |
| Energy [Btu/h] | 1.108E+07 | 7.296E+07 | 9.931E+07 | 2.169E+06 |
| H [Btu/lbmol] | 2.717E+03 | 2.704E+03 | 3.680E+03 | 1.549E+03 |
| S [Btu/lbmol-F] | 28.1 | 28.7 | 30.7 | 36.7 |
| MolecularWeight | 43.6 | 42.5 | 42.5 | 55.1 |
| MassDensity [lb/ft³] | 2.4 | 2.4 | 1.7 | 31.6 |
| Cp [Btu/lbmol-F] | 10.6 | 10.4 | 10.0 | 39.0 |
| ThermalConductivity | 0.008 | 0.009 | 0.011 | 0.047 |
| [Btu/h-ft-F] | | | | |
| Viscosity [cP] | 0.013 | 0.013 | 0.015 | 0.086 |
| molarV [ft³/lbmol] | 17.890 | 17.838 | 24.481 | 1.744 |
| ZFactor | 0.832 | 0.836 | 0.917 | 0.063 |

TABLE 4F

| | Partially | | Regulated |
|---|---|---|---|
| | vaporized | Third liquid | third liquid |
| | intermediate | fraction | fraction |
| | stream | stream | stream |
| | 188 | 176 | 395 |
| VapFrac | 0.67 | 0.00 | 0.00 |
| T [F] | 195.1 | 195.1 | 195.1 |
| P [psia] | 239.0 | 239.0 | 239.0 |
| MoleFlow [lbmol/h] | 1.401E+03 | 4.636E+02 | 4.636E+02 |
| MassFlow [lb/h] | 7.724E+04 | 2.877E+04 | 2.877E+04 |
| VolumeFlow [bbl/d] | 9.393E+04 | 3.884E+03 | 3.884E+03 |
| StdLiqVolumeFlow | 9.185E+03 | 3.304E+03 | 3.304E+03 |
| [bbl/d] | | | |
| StdGasVolumeFlow | 12.8 | 4.2 | 4.2 |
| [MMSCFD] | | | |
| Energy [Btu/h] | 9.516E+06 | 1.432E+06 | 1.432E+06 |
| H [Btu/lbmol] | 6.794E+03 | 3.089E+03 | 3.089E+03 |
| S [Btu/lbmol-F] | 44.9 | 41.0 | 41.0 |
| MolecularWeight | 55.1 | 62.1 | 62.1 |
| MassDensity [lb/ft³] | 3.5 | 31.7 | 31.7 |
| Cp [Btu/lbmol-F] | 32.9 | 44.5 | 44.5 |
| ThermalConductivity | 0.026 | 0.046 | 0.046 |
| [Btu/h-ft-F] | | | |
| Viscosity [cP] | 0.024 | 0.090 | 0.090 |
| molarV [ft³/lbmol] | 15.689 | 1.960 | 1.960 |
| ZFactor | 0.536 | 0.067 | 0.067 |

TABLE 4G

| | NGL rich | Propane rich |
|---|---|---|
| | stream | stream |
| | 352 | 398 |
| VapFrac | 0.00 | 0.00 |
| T [F] | 241.7 | 93.8 |
| P [psia] | 210.0 | 206.0 |
| MoleFlow [lbmol/h] | 3.335E+02 | 1.301E+02 |
| MassFlow [lb/h] | 2.308E+04 | 5.693E+03 |
| VolumeFlow [bbl/d] | 3.161E+03 | 7.897E+02 |
| StdLiqVolumeFlow | 2.559E+03 | 7.449E+02 |
| [bbl/d] | | |
| StdGasVolumeFlow | 3.0 | 1.2 |
| [MMSCFD] | | |
| Energy [Btu/h] | 1.789E+06 | −9.721E+03 |
| H [Btu/lbmol] | 5.363E+03 | −7.469E+01 |
| S [Btu/lbmol-F] | 44.2 | 32.5 |
| MolecularWeight | 69.2 | 43.7 |
| MassDensity [lb/ft³] | 31.2 | 30.8 |
| Cp [Btu/lbmol-F] | 51.6 | 31.4 |
| ThermalConductivity | 0.044 | 0.049 |
| [Btu/h-ft-F] | | |
| Viscosity [cP] | 0.089 | 0.087 |
| molarV [ft³/lbmol] | 2.217 | 1.419 |
| ZFactor | 0.063 | 0.048 |

TABLE 4H

| | | | Partially | |
|---|---|---|---|---|
| | | | vaporized | |
| | | Sub-cooled | cold | |
| | Refrigerant | refrigerant | refrigerant | Refrigerant |
| | liquid stream | liquid stream | liquid stream | vapor stream |
| | 166 | 202 | 124 | 206 |
| VapFrac | 0.00 | 0.00 | 0.13 | 1.00 |
| T [F] | 120.0 | 5.0 | −33.6 | −31.9 |
| P [psia] | 250.5 | 250.5 | 19.5 | 19.0 |
| MoleFlow [lbmol/h] | 5.244E+03 | 5.244E+03 | 5.244E+03 | 5.244E+03 |
| MassFlow [lb/h] | 2.309E+05 | 2.309E+05 | 2.309E+05 | 2.309E+05 |
| VolumeFlow [bbl/d] | 3.502E+04 | 2.849E+04 | 6.593E+05 | 5.197E+06 |
| StdLiqVolumeFlow | 3.142E+04 | 3.142E+04 | 3.142E+04 | 3.142E+04 |
| [bbl/d] | | | | |
| StdGasVolumeFlow | 47.8 | 47.8 | 47.8 | 47.8 |
| [MMSCFD] | | | | |
| Energy [Btu/h] | 4.542E+06 | −1.324E+07 | −1.324E+07 | 2.360E+07 |
| H [Btu/lbmol] | 8.661E+02 | −2.525E+03 | −2.525E+03 | 4.501E+03 |
| S [Btu/lbmol-F] | 33.9 | 27.4 | 27.6 | 44.1 |
| MolecularWeight | 44.0 | 44.0 | 44.0 | 44.0 |
| MassDensity [lb/ft³] | 28.2 | 34.6 | 1.5 | 0.2 |
| Cp [Btu/lbmol-F] | 35.6 | 25.9 | 23.4 | 15.6 |
| ThermalConductivity | 0.045 | 0.069 | 0.068 | 0.007 |
| [Btu/h-ft-F] | | | | |
| Viscosity [cP] | 0.076 | 0.156 | 0.144 | 0.007 |
| molarV [ft³/lbmol] | 1.562 | 1.271 | 29.413 | 231.854 |
| ZFactor | 0.063 | 0.060 | 0.125 | 0.960 |

TABLE 4I

| | | Cooled heat |
|---|---|---|
| | Heat medium | medium |
| | stream | stream |
| Stream | 186 | 208 |
| VapFrac | 0.00 | 0.00 |
| T [F] | 350.0 | 300.0 |
| P [psia] | 90.0 | 85.0 |
| MoleFlow [lbmol/h] | 9.083E+02 | 9.083E+02 |
| MassFlow [lb/h] | 2.907E+05 | 2.907E+05 |
| VolumeFlow [bbl/d] | 2.450E+04 | 2.414E+04 |
| StdLiqVolumeFlow | 2.285E+04 | 2.285E+04 |
| [bbl/d] | | |
| StdGasVolumeFlow | 8.3 | 8.3 |
| [MMSCFD] | | |
| Energy [Btu/h] | 4.835E+07 | 4.100E+07 |
| H [Btu/lbmol] | 5.323E+04 | 4.514E+04 |
| S [Btu/lbmol-F] | 239.6 | 229.3 |
| MolecularWeight | 320.0 | 320.0 |
| MassDensity [lb/ft³] | 50.7 | 51.5 |
| Cp [Btu/lbmol-F] | 165.9 | 157.4 |
| ThermalConductivity | 0.063 | 0.064 |
| [Btu/h-ft-F] | | |
| Viscosity [cP] | 0.947 | 1.293 |
| molarV [ft³/lbmol] | 6.311 | 6.216 |
| ZFactor | 0.073 | 0.072 |

TABLE 5A

| | | | | Partially |
|---|---|---|---|---|
| | Dehydrated | | | condensed |
| | carbon | Cold carbon | First vapor | first vapor |
| | dioxide | dioxide | fraction | fraction |
| | recycle stream | recycle | stream | stream |
| | 46 | stream 106 | 112 | 126 |
| Hydrogen | 0.090 | 0.090 | 0.084 | 0.084 |
| Nitrogen | 0.891 | 0.891 | 0.836 | 0.836 |
| Carbon | 89.902 | 89.902 | 91.828 | 91.828 |
| dioxide | | | | |
| Hydrogen | 0.901 | 0.901 | 0.881 | 0.881 |
| sulfide | | | | |
| Methane | 3.272 | 3.272 | 3.071 | 3.071 |
| Ethane | 1.951 | 1.951 | 1.835 | 1.835 |
| Propane | 1.691 | 1.691 | 1.351 | 1.351 |
| Isobutane | 0.220 | 0.220 | 0.066 | 0.066 |
| n-Butane | 0.530 | 0.530 | 0.043 | 0.043 |
| Isopentane | 0.140 | 0.140 | 0.000 | 0.000 |
| n-Pentane | 0.140 | 0.140 | 0.000 | 0.000 |
| n-Hexane | 0.110 | 0.110 | 0.000 | 0.000 |
| n-Heptane | 0.100 | 0.100 | 0.000 | 0.000 |
| n-Octane | 0.030 | 0.030 | 0.000 | 0.000 |
| n-Nonane | 0.010 | 0.010 | 0.000 | 0.000 |
| Water | 0.000 | 0.000 | 0.000 | 0.000 |
| Triethylene | 0.000 | 0.000 | 0.000 | 0.000 |
| glycol | | | | |
| Carbonyl | 0.015 | 0.015 | 0.004 | 0.004 |
| sulfide | | | | |
| Methyl | 0.006 | 0.006 | 0.000 | 0.000 |
| mercaptan | | | | |

TABLE 5B

| | | | | First |
|---|---|---|---|---|
| | | Second | Pressurized | pressurized |
| | Second vapor | liquid | second liquid | second liquid |
| | fraction | fraction | fraction | fraction |
| | stream | stream | stream | stream |
| | 134 | 136 | 142 | 144 |
| Hydrogen | 0.108 | 0.000 | 0.000 | 0.000 |
| Nitrogen | 1.060 | 0.037 | 0.037 | 0.037 |
| Carbon | 90.832 | 95.376 | 95.376 | 95.376 |
| dioxide | | | | |
| Hydrogen | 0.817 | 1.110 | 1.110 | 1.110 |
| sulfide | | | | |
| Methane | 3.850 | 0.296 | 0.296 | 0.296 |
| Ethane | 2.101 | 0.886 | 0.886 | 0.886 |
| Propane | 1.162 | 2.028 | 2.028 | 2.028 |
| Isobutane | 0.043 | 0.147 | 0.147 | 0.147 |
| n-Butane | 0.024 | 0.109 | 0.109 | 0.109 |
| Isopentane | 0.000 | 0.000 | 0.000 | 0.000 |
| n-Pentane | 0.000 | 0.000 | 0.000 | 0.000 |
| n-Hexane | 0.000 | 0.000 | 0.000 | 0.000 |
| n-Heptane | 0.000 | 0.000 | 0.000 | 0.000 |
| n-Octane | 0.000 | 0.000 | 0.000 | 0.000 |
| n-Nonane | 0.000 | 0.000 | 0.000 | 0.000 |
| Water | 0.000 | 0.000 | 0.000 | 0.000 |
| Triethylene | 0.000 | 0.000 | 0.000 | 0.000 |
| glycol | | | | |
| Carbonyl | 0.002 | 0.010 | 0.010 | 0.010 |
| sulfide | | | | |
| Methyl | 0.000 | 0.000 | 0.000 | 0.000 |
| mercaptan | | | | |

TABLE 5C

| | | | Pressurized | Regulated |
|---|---|---|---|---|
| | | First liquid | first liquid | first liquid |
| | Cold reflux | fraction | fraction | fraction |
| | liquids stream | stream | stream | stream |
| | 118 | 114 | 158 | 162 |
| Hydrogen | 0.000 | 0.000 | 0.000 | 0.000 |
| Nitrogen | 0.037 | 0.036 | 0.036 | 0.036 |
| Carbon | 95.376 | 83.196 | 83.196 | 83.196 |
| dioxide | | | | |
| Hydrogen | 1.110 | 1.365 | 1.365 | 1.365 |
| sulfide | | | | |
| Methane | 0.296 | 0.370 | 0.370 | 0.370 |
| Ethane | 0.886 | 1.255 | 1.255 | 1.255 |
| Propane | 2.028 | 4.823 | 4.823 | 4.823 |
| Isobutane | 0.147 | 1.304 | 1.304 | 1.304 |
| n-Butane | 0.109 | 3.670 | 3.670 | 3.670 |
| Isopentane | 0.000 | 1.014 | 1.014 | 1.014 |
| n-Pentane | 0.000 | 1.014 | 1.014 | 1.014 |
| n-Hexane | 0.000 | 0.797 | 0.797 | 0.797 |
| n-Heptane | 0.000 | 0.724 | 0.724 | 0.724 |
| n-Octane | 0.000 | 0.217 | 0.217 | 0.217 |
| n-Nonane | 0.000 | 0.072 | 0.072 | 0.072 |
| Water | 0.000 | 0.000 | 0.000 | 0.000 |
| Triethylene | 0.000 | 0.000 | 0.000 | 0.000 |
| glycol | | | | |
| Carbonyl | 0.010 | 0.096 | 0.096 | 0.096 |
| sulfide | | | | |
| Methyl | 0.000 | 0.040 | 0.040 | 0.040 |
| mercaptan | | | | |

TABLE 5D

| | | Second | | |
|---|---|---|---|---|
| | | pressurized | | |
| | | second liquid | Second | Third vapor |
| | Two-phase | fraction | cold reflux | fraction |
| | stream | stream | liquids stream | stream |
| | 168 | 146 | 154 | 172 |
| Hydrogen | 0.000 | 0.000 | 0.000 | 0.000 |
| Nitrogen | 0.036 | 0.037 | 0.037 | 0.040 |
| Carbon | 83.196 | 95.376 | 95.376 | 94.892 |
| dioxide | | | | |
| Hydrogen | 1.365 | 1.110 | 1.110 | 1.254 |
| sulfide | | | | |
| Methane | 0.370 | 0.296 | 0.296 | 0.398 |
| Ethane | 1.255 | 0.886 | 0.886 | 1.315 |
| Propane | 4.823 | 2.028 | 2.028 | 1.935 |
| Isobutane | 1.304 | 0.147 | 0.147 | 0.085 |
| n-Butane | 3.670 | 0.109 | 0.109 | 0.062 |
| Isopentane | 1.014 | 0.000 | 0.000 | 0.000 |
| n-Pentane | 1.014 | 0.000 | 0.000 | 0.000 |
| n-Hexane | 0.797 | 0.000 | 0.000 | 0.000 |
| n-Heptane | 0.724 | 0.000 | 0.000 | 0.000 |
| n-Octane | 0.217 | 0.000 | 0.000 | 0.000 |
| n-Nonane | 0.072 | 0.000 | 0.000 | 0.000 |
| Water | 0.000 | 0.000 | 0.000 | 0.000 |
| Triethylene | 0.000 | 0.000 | 0.000 | 0.000 |
| glycol | | | | |
| Carbonyl | 0.096 | 0.010 | 0.010 | 0.017 |
| sulfide | | | | |
| Methyl | 0.040 | 0.000 | 0.000 | 0.000 |
| mercaptan | | | | |

TABLE 5E

| | Regulated | | Residual | |
|---|---|---|---|---|
| | third | Combined | carbon | Intermediate |
| | vapor fraction | carbon | dioxide | liquid fraction |
| | stream | dioxide | recycle | stream |
| | 182 | stream 104 | stream 54 | 174 |
| Hydrogen | 0.000 | 0.092 | 0.092 | 0.000 |
| Nitrogen | 0.040 | 0.906 | 0.906 | 0.000 |
| Carbon | 94.892 | 91.446 | 91.446 | 0.104 |
| dioxide | | | | |
| Hydrogen | 1.254 | 0.883 | 0.883 | 5.091 |
| sulfide | | | | |
| Methane | 0.398 | 3.328 | 3.328 | 0.000 |
| Ethane | 1.315 | 1.983 | 1.983 | 0.365 |
| Propane | 1.935 | 1.279 | 1.279 | 39.146 |
| Isobutane | 0.085 | 0.050 | 0.050 | 10.264 |
| n-Butane | 0.062 | 0.030 | 0.030 | 26.510 |
| Isopentane | 0.000 | 0.000 | 0.000 | 5.449 |
| n-Pentane | 0.000 | 0.000 | 0.000 | 5.214 |
| n-Hexane | 0.000 | 0.000 | 0.000 | 3.049 |
| n-Heptane | 0.000 | 0.000 | 0.000 | 2.385 |
| n-Octane | 0.000 | 0.000 | 0.000 | 0.654 |
| n-Nonane | 0.000 | 0.000 | 0.000 | 0.207 |
| Water | 0.000 | 0.000 | 0.000 | 0.000 |
| Triethylene | 0.000 | 0.000 | 0.000 | 0.000 |
| glycol | | | | |
| Carbonyl | 0.017 | 0.004 | 0.004 | 1.161 |
| sulfide | | | | |
| Methyl | 0.000 | 0.000 | 0.000 | 0.364 |
| mercaptan | | | | |

TABLE 5F

| | Partially | | Regulated |
|---|---|---|---|
| | vaporized | Third liquid | third liquid |
| | intermediate | fraction | fraction |
| | stream | stream | stream |
| | 188 | 176 | 395 |
| Hydrogen | 0.000 | 0.000 | 0.000 |
| Nitrogen | 0.000 | 0.000 | 0.000 |
| Carbon | 0.104 | 0.023 | 0.023 |
| dioxide | | | |
| Hydrogen | 5.091 | 1.925 | 1.925 |
| sulfide | | | |
| Methane | 0.000 | 0.000 | 0.000 |
| Ethane | 0.365 | 0.129 | 0.129 |
| Propane | 39.146 | 25.706 | 25.706 |
| Isobutane | 10.264 | 10.151 | 10.151 |
| n-Butane | 26.510 | 29.641 | 29.641 |
| Isopentane | 5.449 | 8.294 | 8.294 |
| n-Pentane | 5.214 | 8.294 | 8.294 |
| n-Hexane | 3.049 | 6.516 | 6.516 |
| n-Heptane | 2.385 | 5.922 | 5.922 |
| n-Octane | 0.654 | 1.775 | 1.775 |
| n-Nonane | 0.207 | 0.591 | 0.591 |
| Water | 0.000 | 0.000 | 0.000 |
| Triethylene | 0.000 | 0.000 | 0.000 |
| glycol | | | |
| Carbonyl | 1.161 | 0.655 | 0.655 |
| sulfide | | | |
| Methyl | 0.364 | 0.326 | 0.326 |
| mercaptan | | | |

TABLE 5G

| | NGL rich | Propane rich |
|---|---|---|
| | stream | stream |
| | 352 | 398 |
| Hydrogen | 0.000 | 0.000 |
| Nitrogen | 0.000 | 0.000 |
| Carbon | 0.000 | 0.081 |
| dioxide | | |
| Hydrogen | 0.000 | 6.858 |
| sulfide | | |
| Methane | 0.000 | 0.000 |
| Ethane | 0.000 | 0.458 |
| Propane | 0.641 | 89.934 |
| Isobutane | 14.063 | 0.127 |
| n-Butane | 41.198 | 0.025 |
| Isopentane | 11.530 | 0.000 |
| n-Pentane | 11.530 | 0.000 |
| n-Hexane | 9.059 | 0.000 |
| n-Heptane | 8.232 | 0.000 |
| n-Octane | 2.468 | 0.000 |
| n-Nonane | 0.821 | 0.000 |
| Water | 0.000 | 0.000 |
| Triethylene | 0.000 | 0.000 |
| glycol | | |
| Carbonyl | 0.001 | 2.332 |
| sulfide | | |
| Methyl | 0.381 | 0.184 |
| mercaptan | | |

The recovery percentages for each of propane, isobutane, n-butane and C₅₊ for this example, calculated on a dry sweet basis, are provided in Tables 6A and 6B:

TABLE 6A

| | Dehydrated | | |
|---|---|---|---|
| | carbon | First liquid | Third liquid |
| | dioxide | fraction | fraction |
| | recycle stream | stream | stream |
| | 46 | 114 | 176 |
| Propane | 100 | 39.4 | 25.7 |
| Isobutane | 100 | 81.8 | 77.9 |
| n-Butane | 100 | 95.6 | 94.4 |
| C₅₊ | 100 | 100 | 100 |

TABLE 6B

| | NGL rich | Propane rich |
|---|---|---|
| | stream | stream |
| | 352 | 398 |
| Propane | 0.5 | 25.2 |
| Isobutane | 77.6 | 0.3 |
| n-Butane | 94.4 | 0.1 |
| C₅₊ | 100 | 0.0 |

Although embodiments have been described above with reference to the accompanying drawings, those of skill in the art will appreciate that variations and modifications may be made without departing from the scope thereof as defined by the appended claims.

What is claimed is:

1. A method, comprising:
providing a carbon dioxide recycle stream comprising natural gas liquids;
separating, using a first distillation tower, the carbon dioxide recycle stream into a first vapor fraction and a first liquid fraction;
cooling and partially condensing the first vapor fraction in a heat exchanger to yield a first carbon dioxide stream and a reflux stream; and
separating, using a second distillation tower, the first liquid fraction into a second carbon dioxide stream and a natural gas liquids rich stream.

2. The method of claim 1, wherein the natural gas liquids rich stream comprises substantially none of the propane from the carbon dioxide recycle stream.

3. The method of claim 1, further comprising adding at least a portion of the reflux stream to the first distillation tower as reflux.

4. The method of claim 1, further comprising adding at least a portion of the reflux stream to the second distillation tower as reflux.

5. The method of claim 1, further comprising passing the first liquid fraction through an additional heat exchanger heated by a refrigerant stream to at least partially vaporize the first liquid fraction.

6. The method of claim 5, wherein the refrigerant stream comprises refrigerant liquid that subcools as it passes through the additional heat exchanger.

7. The method of claim 1, further comprising combining the first carbon dioxide stream and the second carbon dioxide stream to yield a residual carbon dioxide stream.

8. The method of claim 1, further comprising processing the natural gas liquids rich stream in a depropanizer to yield a propane rich stream and a processed natural gas liquids rich stream.

9. The method of claim 8, further comprising removing traces of one or more of carbon dioxide, hydrogen sulfide, and sulphur compounds from the natural gas liquids rich stream using an additional treatment unit.

10. The method of claim 8, further comprising removing traces of one or more of carbon dioxide, hydrogen sulfide, and sulphur compounds from the processed natural gas liquids rich stream using an additional treatment unit.

11. The method of claim 8, wherein the processed natural gas liquids rich stream comprises substantially none of the propane from the carbon dioxide recycle stream.

12. An apparatus, comprising:
a first distillation tower configured to separate a carbon dioxide recycle stream into a first vapor fraction and a first liquid fraction, the carbon dioxide recycle stream comprising natural gas liquids;
a heat exchanger configured to cool and partially condense the first vapor fraction into a first carbon dioxide stream and a reflux stream; and
a second distillation tower configured to separate the first liquid fraction into a second carbon dioxide stream and a natural gas liquids rich stream.

13. The apparatus of claim 12, wherein the natural gas liquids rich stream comprises substantially none of the propane from the carbon dioxide recycle stream.

14. The apparatus of claim 12, wherein at least a portion of the reflux stream is added to the first distillation tower as reflux.

15. The apparatus of claim 12, wherein at least a portion of the reflux stream is added to the second distillation tower as reflux.

16. The apparatus of claim 12, further comprising an additional heat exchanger heated by a refrigerant stream, the additional heat exchanger being configured to at least partially vaporize the first liquid fraction.

17. The apparatus of claim 16, wherein the refrigerant stream comprises refrigerant liquid that subcools as it passes through the additional heat exchanger.

18. The apparatus of claim 12, further comprising a depropanizer configured to process the natural gas liquids rich stream to yield a propane rich stream and a processed natural gas liquids rich stream.

19. The apparatus of claim 18, further comprising an additional treatment unit configured to remove traces of one or more of carbon dioxide, hydrogen sulfide, and sulphur compounds from the natural gas liquids rich stream.

20. The apparatus of claim 18, further comprising an additional treatment unit configured to remove traces of one or more of carbon dioxide, hydrogen sulfide, and sulphur compounds from the processed natural gas liquids rich stream.
